(19) United States
(12) Patent Application Publication
(10) Pub. No.: US 2026/0289458 A1
(43) Pub. Date: Sep. 24, 2026

(54) SYSTEM

(71) Applicant: SoftBank Group Corp., Tokyo (JP)

(72) Inventor: Tomo SUZUKI, Tokyo (JP)

(73) Assignee: SoftBank Group Corp., Tokyo (JP)

(21) Appl. No.: 19/562,865

(22) Filed: Mar. 11, 2026

(30) Foreign Application Priority Data
Mar. 19, 2025 (JP) 2025-044958

(51) Int. Cl. G06Q 10/0633; G06N 3/0475; G10L 25/63

(52) U.S. Cl. CPC G06Q 10/0633; G06N 3/0475; G10L 25/63

(57) ABSTRACT

A system includes a processor that is configured to: receive information from a user, generate a prompt to instruct a generative AI model to automatically generate responses including an industry analysis, industry challenges, and proposed measures based on the received information, control a process in which a human expert reviews the generated responses and prepares a final response, and use an electronic communication means to report to the user a procedure of querying the generative AI model and an analysis result.

### CROSS-REFERENCE TO RELATED APPLICATION

This application is based on and claims priority under 35 USC 119 from Japanese Patent Application No. 2025-044958 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional consultation support systems for small and medium-sized enterprises and other business users typically rely either on static knowledge bases or on direct interaction with human experts. Such systems suffer from several problems, including limited scalability, high cost per consultation, long turnaround time, and inconsistency in the depth and structure of the analysis provided to users. Recently, generative AI models have been introduced to support business analysis; however, existing approaches often lack transparency regarding how the AI reached its conclusions, provide little or no expert verification of AI-generated content, and do not adapt the tone or content of responses to the emotional state of the user. As a result, users may distrust the output of the AI system, misunderstand the analytical processes behind the advice, or feel that the responses are not empathetic or appropriately tailored to their concerns. There is therefore a need for a system that combines generative AI with expert review, that clearly reports the AI query procedure and analytical results, and that further adjusts the generated responses based on user emotions, while delivering the final information through electronic communication means or web platforms in a structured and comprehensible digital format.

### SUMMARY

In order to solve the above-described problems, a system according to the present invention comprises a processor configured to receive information from a user and generate a prompt to instruct a generative AI model to automatically generate responses including an industry analysis, industry challenges, and proposed measures based on the received information. The processor is further configured to control a process in which a human expert reviews the AI-generated responses and prepares a final response, and to use an electronic communication means to report to the user a procedure of querying the generative AI model and an analysis result. In one aspect, the processor is configured to use an emotion engine to analyze an emotion of the user and to adjust the generated responses based on a result of the emotion analysis, thereby tailoring the content and tone of the responses to the user's emotional state. In another aspect, the processor is configured to organize, in a digital format, information including the procedure of querying the generative AI model, the analysis result, and an emotion analysis result generated by the emotion engine, and to transmit the organized information using an electronic communication means or provide the organized information on a web platform. By these means, the system can provide transparent, expert-verified, and emotionally adaptive consultation outputs that are structured and delivered in a consistent and user-friendly manner.

The term “processor” refers to a hardware or software processing unit, such as a CPU, GPU, microcontroller, or a combination thereof, and associated control logic and programs, that executes instructions to perform the functions described in the present specification and claims.

The term “user” refers to a person or entity that provides information or consultation content to the system and receives analysis results, responses, and reports generated by the system.

The term “information from a user” refers to data provided by the user, including but not limited to company information, contact information, consultation topics, questions, descriptions of business conditions, and any other relevant textual or structured input.

The term “prompt” refers to a structured input, including text and optionally additional parameters or metadata, that is generated by the processor and supplied to a generative AI model to instruct the model to produce a response with specific content and structure.

The term “generative AI model” refers to an artificial intelligence model, such as a large language model or similar machine learning system, that is configured to generate text or other content in response to an input prompt.

The term “industry analysis” refers to an analytical description of an industry relevant to the user's consultation, including, for example, market structure, market size, trends, growth potential, competitive landscape, and other sector-specific characteristics.

The term “industry challenges” refers to issues, risks, constraints, or problems that typically arise in a particular industry or business domain relevant to the user's consultation.

The term “proposed measures” refers to strategies, action plans, recommendations, or countermeasures generated by the system, which are intended to address the identified industry challenges or support the user's business decisions.

The term “human expert” refers to a person having expertise in a relevant business, technical, legal, or other domain, who reviews, validates, corrects, supplements, or approves content that is generated by the generative AI model.

The term “final response” refers to a response produced after review by the human expert, including any modifications, additions, or approvals made by the expert to the original AI-generated content, and which is intended to be delivered to the user.

The term “procedure of querying the generative AI model” refers to a sequence of steps, including prompt generation, parameter selection, and invocation of the generative AI model, by which the system requests and obtains responses from the generative AI model.

The term “analysis result” refers to the outcome produced by the generative AI model and, where applicable, refined by the human expert, including industry analysis, industry challenges, proposed measures, and any other analytical findings relevant to the user's consultation.

The term “electronic communication means” refers to any electronic method or channel for transmitting information to the user, including but not limited to e-mail, messaging systems, application notifications, and electronic document delivery systems.

The term “emotion engine” refers to a software component or module that analyzes user-related data, such as text, voice, or other signals, to infer or estimate the emotional state or sentiment of the user.

The term “emotion of the user” refers to an inferred emotional state, such as satisfaction, anxiety, confidence, frustration, or other affective conditions, derived from the user's input or interaction by the emotion engine.

The term “emotion analysis result” refers to data or parameters produced by the emotion engine that represent the evaluated emotional state or sentiment of the user.

The term “digital format” refers to an electronically processable and storable representation of information, such as structured text, JSON, XML, HTML, PDF, or other machine-readable data formats.

The term “web platform” refers to a server-based system, including web servers, web applications, or cloud services, that provides user-accessible interfaces via a network, such as web pages or web-based dashboards, for presenting information organized by the processor.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

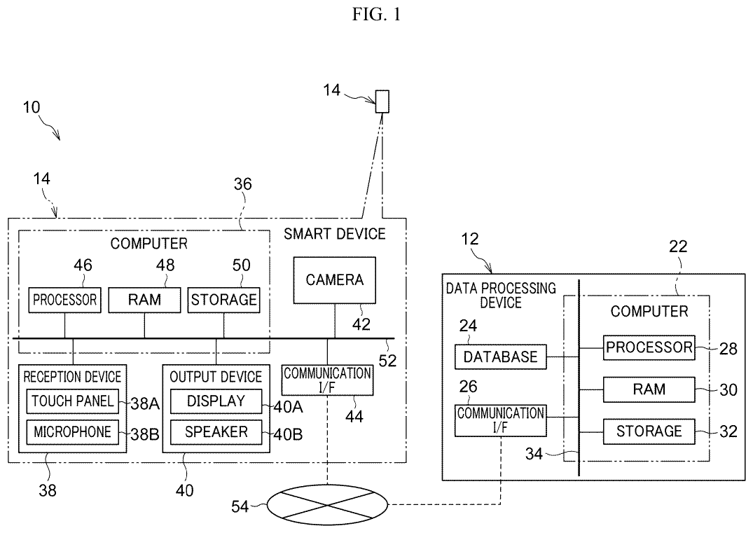

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

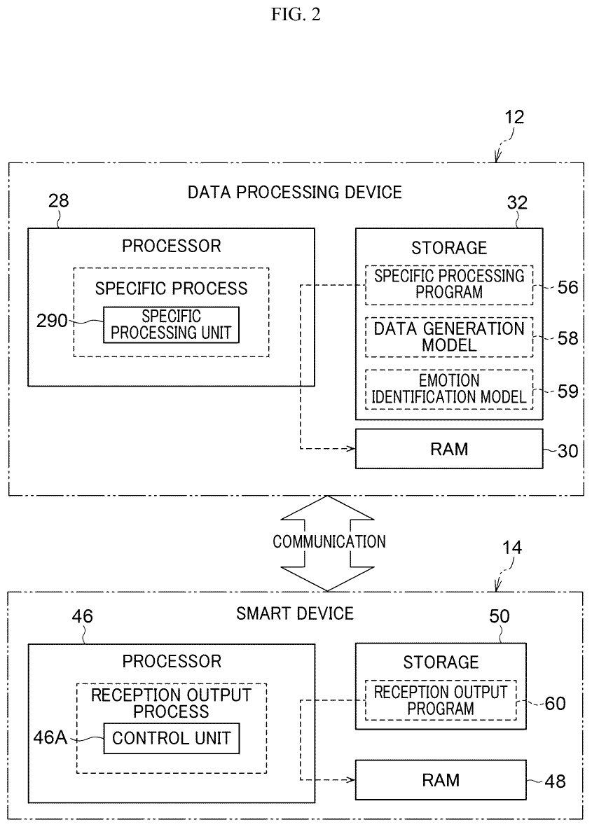

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented support systems for business analysis and proposal generation generally rely on either manual expert work or on direct use of automated models that output proposals without systematic control or verification. When a user submits free-form consultation content through a generic input form, existing systems typically (i) pass the text directly to a generative AI model without dynamically structuring the instructions, or (ii) merely store the text for later human processing. As a result, the utilization of computational resources is inefficient, the generated output often lacks consistent structure, and it is difficult to trace how a particular answer was derived from user input.

In particular, in a networked environment where a server cooperates with a generative AI model provided by an external information processing service, several technical issues arise.

First, the server is not configured to systematically transform heterogeneous user consultation content into category-specific prompt sentences that reliably guide the generative AI model to produce outputs with a predefined structure, such as distinct sections for industry analysis, industry issues, and initiatives. This leads to unstable output quality and increased post-processing load on the server.

Second, existing architectures do not integrate, within a cohesive server-side control flow, storage and association of the generated prompt sentences, the raw AI responses, and expert-verified final answers as machine-readable processing history. Without such integrated control, the server cannot efficiently manage state transitions of inquiries, reliably reproduce past analysis, or provide the user with a transparent explanation of how the answer was generated. This limits the ability of the system to function as a robust information processing platform rather than a simple message relay.

Third, known systems typically lack a processor configuration that programmatically incorporates expert review into the server-managed data flow. In many cases, human experts interact with AI outputs outside of the server's transactional context, such as through ad hoc communication tools, and the integration of corrections into a final, machine-tracked answer is manual and error prone. This reduces reliability, makes it difficult for the server to enforce quality and consistency, and hinders scalable deployment.

Fourth, in terms of user experience and adaptive output, conventional systems do not couple emotion analysis of user consultations or AI outputs with server-side formatting and presentation control. Even if sentiment analysis tools are available, they are often used only for reporting, not for dynamically adjusting the content or ordering of system-generated responses. Consequently, the server is unable to computationally optimize the way information is presented to the user based on emotion tendency information, reducing the effectiveness of the communication.

Accordingly, there is a need for a computer-implemented system in which the server's processor is technically configured to: (i) receive and analyze structured and unstructured consultation information from a terminal, (ii) estimate categories and construct structured prompt sentences for a generative AI model, (iii) manage receipt and post-processing of AI-generated answers as draft answer data, (iv) orchestrate expert review and correction steps within the same server-side transaction framework, (v) record prompt sentences, AI outputs, expert-verified final answers, and processing history in a unified digital format, and (vi) optionally perform emotion analysis and adjust presentation of the final information. Such a configuration improves the functioning of the computer system itself by enforcing structured data flows, predictable AI utilization, and traceable processing pipelines, thereby enhancing efficiency, scalability, and transparency of industry analysis and proposal generation services.

The specific processing by the specific processing unit 290 of the data processing device 12 in Example 1 is realized by the following means.

The present invention provides a server comprising a processor configured to receive, via a communication network from a terminal, input information including organization attribute information, user attribute information, and consultation content information that a user has entered through an information input screen, analyze the input information, and store the analyzed information as inquiry data including the consultation content information; estimate, based on the consultation content information, at least one of an industry category and an issue category, refer to template information associated with a result of the estimation, and construct a prompt sentence that instructs a generative AI model to generate output including at least industry analysis information, industry issue information, and initiative information; transmit the prompt sentence, in accordance with a communication protocol, to an external information processing service that includes the generative AI model; receive, from the generative AI model in response to the prompt sentence, answer text, perform at least one of formatting processing, safety checking processing, and structuring processing on the answer text, and store the processed answer text as draft answer data including the industry analysis information, the industry issue information, and the initiative information; provide, via the communication network, the draft answer data and the consultation content information to a terminal of an evaluator having expert knowledge, receive correction information transmitted from the terminal of the evaluator, and generate expert-verified final answer data by reflecting the correction information in the draft answer data; and organize the prompt sentence, the answer text obtained from the generative AI model, the expert-verified final answer data, and processing history information including procedures for obtaining the answer text by using the generative AI model into digital information in a message format or a viewing-screen format, and transmit or provide the digital information to the user by using an electronic communication means. This enables the computer system to implement an integrated, processor-controlled pipeline that converts unstructured consultation input into category-specific prompt sentences, orchestrates interaction with a generative AI model, incorporates expert review within the same transactional framework, and returns structured, traceable analysis reports to the user, thereby improving the efficiency, reliability, and transparency of the underlying information processing architecture.

The term “processor” refers to a hardware or virtual computing element, such as a central processing unit or processing circuitry executed by a computing device, that is configured to execute instructions for performing the functions described in the present disclosure.

The term “terminal” refers to an electronic device operated by a user or an evaluator, such as a client computing device or communication device, that is capable of transmitting information to and receiving information from a server via a communication network.

The term “communication network” refers to a wired or wireless data communication infrastructure, including at least one of a local area network, a wide area network, and a public network, that enables data exchange between the server, the terminal, and an external information processing service.

The term “information input screen” refers to a user interface presented on a terminal, including at least one of a web page and an application screen, that allows a user to input organization attribute information, user attribute information, consultation content information, and other data.

The term “organization attribute information” refers to data items that identify or characterize an organization, including at least one of an organization name, an industry classification, an organization size, and a location.

The term “user attribute information” refers to data items that identify or characterize a user, including at least one of a user name, a role within an organization, and contact information.

The term “consultation content information” refers to text or other data expressing a user's inquiry, problem, or request for analysis or proposals, including at least one of free-form descriptions of business challenges, objectives, or desired strategies.

The term “inquiry data” refers to structured data stored by the server that includes at least the consultation content information and may further include organization attribute information, user attribute information, timestamps, and status information associated with a consultation.

The term “industry category” refers to a classification code or label that indicates a sector or field of economic activity relevant to the consultation content information.

The term “issue category” refers to a classification code or label that indicates a type of problem, challenge, or topic, such as cost reduction, marketing strategy, or market entry, associated with the consultation content information.

The term “template information” refers to predefined data structures, patterns, or text templates that are stored in a storage device and are associated with at least one of an industry category and an issue category for use in constructing a prompt sentence.

The term “prompt sentence” refers to a text string or sequence of textual instructions generated by the processor, which is sent to a generative AI model in order to specify at least a requested output type, structure, or content.

The term “generative AI model” refers to a machine-learned model, such as a large language model, that generates output text or other content in response to an input such as a prompt sentence, based on parameters obtained through training on data.

The term “external information processing service” refers to a remote computing service, accessible via a communication network, that executes the generative AI model and returns generated output to the server in response to a request.

The term “answer text” refers to text data generated by the generative AI model in response to a prompt sentence, including at least a portion of the content requested by the prompt sentence.

The term “industry analysis information” refers to a part of the answer text or processed text that describes characteristics, trends, or structures of a relevant industry associated with the consultation content information.

The term “industry issue information” refers to a part of the answer text or processed text that identifies problems, challenges, or risks present in the relevant industry associated with the consultation content information.

The term “initiative information” refers to a part of the answer text or processed text that proposes actions, measures, or strategies to address at least one of the identified industry issues or user challenges.

The term “formatting processing” refers to processing that modifies layout or representation of text data, including at least one of adding headings, bullet points, or sections, and adjusting spacing or punctuation.

The term “safety checking processing” refers to processing that inspects text data to detect and optionally correct or remove content that is inappropriate, harmful, or noncompliant with predetermined safety or policy rules.

The term “structuring processing” refers to processing that converts unstructured text into a structured representation, including at least one of dividing text into labeled sections, tagging content types, or transforming text into a machine-readable data structure.

The term “draft answer data” refers to data representing a provisional response generated by the server based on the answer text, after at least one of formatting processing, safety checking processing, and structuring processing has been applied, and including at least industry analysis information, industry issue information, and initiative information.

The term “evaluator” refers to a person or entity having expert knowledge in a relevant field who reviews, corrects, or supplements the draft answer data and provides correction information to the server.

The term “correction information” refers to data that indicates modifications, additions, or deletions to be applied to the draft answer data, as provided by an evaluator.

The term “expert-verified final answer data” refers to response data generated by the server by applying the correction information from an evaluator to the draft answer data, and representing a finalized answer to be provided to the user.

The term “processing history information” refers to data indicating at least a sequence of operations performed by the server, including generation of a prompt sentence, transmission of the prompt sentence to a generative AI model, reception of answer text, generation of draft answer data, application of correction information, and creation of expert-verified final answer data.

The term “digital information in a message format” refers to data organized for delivery as an electronic message, including at least one of an electronic mail message and a text-based notification, that contains a portion or all of the processing results.

The term “digital information in a viewing-screen format” refers to data organized for presentation on a display device, including at least one of a web page structure and a graphical user interface layout.

The term “electronic communication means” refers to at least one of an electronic mail system, a web-based communication interface, an application programming interface, and other electronic messaging mechanisms capable of transmitting digital information between the server and a terminal.

The term “emotion analysis function” refers to a software component or processing routine that analyzes text data, such as consultation content information or answer text, to determine emotion tendency information, including at least one of positive, negative, and neutral sentiment or other emotional categories.

The term “emotion tendency information” refers to data representing a result of emotion analysis, including at least one of sentiment polarity, emotion strength, and categorized emotional state inferred from text data.

The term “expression content” refers to wording, tone, or style used in text presented to a user, including selection of phrases, level of politeness, and degree of detail.

The term “presentation order” refers to a sequence in which elements of information, such as sections, bullet points, or recommendations, are arranged and displayed to a user.

The term “electronic document format” refers to a structured data format suitable for electronic storage and display of documents, including at least one of a markup-based format and a page description format.

The term “web-screen format” refers to a data representation suitable for rendering by a web browser or similar client, including at least one of a markup structure, style definitions, and associated resources.

The term “analysis report” refers to a collection of organized digital information that includes at least the prompt sentence, answer text from the generative AI model, and expert-verified final answer data, and is provided to the user as a result of processing the consultation content information.

In one embodiment, a server implements the claimed system as a network-accessible application executed on one or more processors. The server runs on hardware that includes at least one central processing unit, a volatile memory, a non-volatile storage device, a network interface, and an operating system such as a general-purpose server operating system. The server executes application software implemented in, for example, a server-side runtime environment such as a script runtime with a web framework or an application framework, and cooperates with middleware such as a web server (for example, an HTTP server) and a database management system (for example, a relational database or a document-oriented database).

The terminal operates as a client device, such as a smartphone, tablet, or personal computer, that executes a web browser (for example, a standards-compliant browser based on a rendering engine) or a dedicated client application. The user operates the terminal to display an information input screen provided by the server, and to transmit and receive data through a communication network such as the Internet or an enterprise network.

The server provides the information input screen as a web page or application view that includes input elements for organization attribute information, user attribute information, and consultation content information. The server stores a representation of the input screen in the form of markup code, style definitions, and client-side scripts within the storage device.

When the terminal requests the input screen, the server transmits the markup, style, and script data to the terminal via the network interface. The terminal renders the input screen by executing the browser's rendering engine, and the user enters text or selections into the displayed input fields.

The server receives the input information as structured data, for example as a structured request body encoded in a common data interchange format. The server parses this structured data using a parsing routine that maps field names to internal data structures such as record objects or key-value maps. The server stores the parsed data as inquiry data in a database.

The inquiry data includes at least a unique identifier, the organization attribute information, the user attribute information, the consultation content information, timestamps, and a status flag indicating a current processing state. By storing the inquiry data in a structured schema, the server enables efficient indexed retrieval and atomic updates, which improves data management consistency and query performance compared to unstructured storage.

The server analyzes the consultation content information to estimate at least one of an industry category and an issue category. In one embodiment, the server uses a hybrid method combining rule-based keyword lookup and a lightweight statistical classifier. For example, the server maintains a dictionary table in the database that maps domain-specific keywords or n-grams to candidate industry categories and issue categories. The server extracts tokens from the consultation content information using a tokenization routine and performs frequency analysis to identify salient tokens. The server then computes category scores by aggregating weights associated with the matched tokens and selects the category (or categories) with highest scores. In another embodiment, the server uses a small neural classifier trained on labeled consultation data to output a probability distribution over categories. The server normalizes the probability distribution and selects categories exceeding a threshold. This category estimation enables the server to select an appropriate prompt template without requiring manual classification by the user, thereby reducing user burden and improving categorization speed.

The server stores a set of prompt templates in the storage device. Each prompt template is associated in the database with at least one industry category and/or issue category, and includes parameterized segments that can be populated with consultation-specific data. The server retrieves the appropriate prompt template based on the estimated category, and constructs a prompt sentence by substituting placeholders with elements of the consultation content information and organization attribute information. The prompt sentence is represented as a text string with clearly defined sections and instructions, so that the generative AI model is guided to output separate sections for industry analysis information, industry issue information, and initiative information.

For example, when the user inputs consultation content such as “I want to consider a new marketing strategy,” the server may generate a prompt sentence of the following form: “Based on the latest trends and competitive analysis in marketing strategies for small and medium-sized enterprises, analyze the current industry environment, identify key challenges, and propose three to five specific and practical marketing initiatives for this organization.

Include both online and offline measures, and explain expected effects and potential risks for each initiative.”

When the user inputs consultation content such as “I want to reduce operating costs,” the server may generate a prompt sentence of the following form:

“Assume you are a consultant specializing in cost reduction for small and medium-sized enterprises in the manufacturing sector. Based on general industry benchmarks and best practices, analyze major cost drivers, identify at least three key areas for cost reduction, and propose concrete measures for each area. For each measure, describe required investments, expected savings, and implementation risks.”

When the user inputs consultation content such as “I want to expand into a new overseas market,” the server may generate a prompt sentence of the following form:

“For a small or medium-sized organization planning to enter a new overseas market, analyze the target market environment, competitive landscape, and regulatory considerations. Identify main opportunities and risks, and propose a phased market entry strategy including partner selection, marketing approach, and organizational structure. Provide recommendations in a step-by-step manner.”

The server may further refine the prompt sentence by inserting specific organization attribute information or a summary of past consultations stored in the database, to allow the generative AI model to consider prior context. The server records the generated prompt sentence in association with the corresponding inquiry identifier, thereby enabling traceability between user input and model instructions.

The server communicates with an external information processing service that executes a generative AI model. In one embodiment, the generative AI model is implemented as a large-scale neural network based on a transformer architecture. The model includes an embedding layer that converts tokens of the prompt sentence into high-dimensional vectors, a plurality of self-attention layers that compute attention weights across token positions, and feed-forward layers that transform intermediate representations. The model has been trained in advance on a large corpus of text data using an unsupervised or self-supervised learning algorithm such as next-token prediction or masked language modeling. During training, the server or the external provider minimizes a loss function, such as cross-entropy loss between predicted token distributions and ground-truth tokens, and updates model parameters (weights and biases) using an optimization algorithm such as stochastic gradient descent or Adam. The training process may include regularization techniques such as dropout, weight decay, and data augmentation (for example, random masking or shuffling of training examples) to improve generalization and reduce overfitting.

At inference time, the server sends the prompt sentence to the external information processing service using a defined application programming interface over a secure communication protocol. The server encodes the prompt sentence as a sequence of tokens according to the tokenizer used by the generative AI model, or delegates tokenization to the external service. The external service runs the generative AI model on specialized hardware such as graphics processing units or tensor processing units, which compute probability distributions over possible next tokens at each step. The model selects next tokens using decoding strategies such as greedy decoding, top-k sampling, or nucleus sampling, until an end-of-sequence condition is met or a maximum length is reached. The service returns the generated answer text to the server in a machine-readable response.

The server receives the answer text and performs post-processing. The server applies formatting processing by inserting or reinforcing explicit section headings such as “Industry Analysis,” “Key Issues,” and “Proposed Initiatives.” The server may perform safety checking processing by scanning the answer text for prohibited patterns or content, using either a rule-based filter (for example, regular expressions against disallowed terms) or a lightweight classifier that detects categories of unsafe content. The server performs structuring processing by parsing the answer text into segments and storing each segment in a structured data format such as a table or document record, thereby enabling efficient retrieval and selective display.

The resulting data is stored as draft answer data linked to the inquiry identifier.

The server sends the draft answer data and the original consultation content information to a terminal operated by an evaluator who has expert knowledge. The server provides an expert interface as a web-based console, which displays the draft answer data in a structured layout and allows the evaluator to edit, annotate, and approve the content. The terminal renders the expert interface and the evaluator uses input devices such as a keyboard or pointing device to modify the draft answer data. The terminal sends the modifications back to the server as correction information.

The server integrates the correction information with the draft answer data to generate expert-verified final answer data. For example, the server maintains a versioned data structure where the draft answer data represents a base version, and the correction information is applied as a set of change operations. The server can compute diffs between versions to record the exact modifications performed by the evaluator. By applying these changes programmatically, the server ensures that the expert-verified final answer data is produced deterministically and reproducibly, thereby improving reliability and enabling later auditing.

In one embodiment, the server also performs emotion analysis processing to adjust the presentation of the answer. The server uses an emotion analysis function implemented as a classifier that processes text features of the consultation content information and/or the answer text. The classifier may be a neural network, such as a bidirectional recurrent network or a transformer-based encoder, trained on labeled sentiment data. The server converts the input text into token embeddings, feeds the embeddings into the classifier, and obtains emotion tendency information such as positive, negative, or neutral polarity and intensity scores. The server uses this emotion tendency information to adjust aspects of the draft answer data or expert-verified final answer data, such as selecting a more cautious or reassuring tone, reordering sections to present supportive information earlier, or adding clarifying explanations. This automated adjustment is performed using server-side logic that applies template variations or phrase-level substitutions based on emotion labels.

The server organizes, for each inquiry, the prompt sentence, the answer text, the draft answer data, the expert-verified final answer data, and processing history information into a digital structure representing an analysis report. The processing history information includes timestamps, identifiers of invoked models, decoding parameters (such as temperature or maximum tokens), identifiers of applied filters, and identifiers of evaluators who provided corrections. The server stores this analysis report in a format suitable for both message delivery and interactive display, such as a markup-based document accompanied by metadata. The server can transmit the analysis report to the user via electronic mail, including the report content directly in the message body or as an attached file, and can also provide a web link that allows the user to view the report through a browser-based viewer. This dual-format organization allows the server to reduce communication overhead by avoiding repeated regeneration of the same content, and to provide both static and interactive views without duplicating storage.

From a technical perspective, the combination of categorized prompt generation, structured post-processing, integrated expert correction, and emotion-based presentation control results in improvements to the computer system itself, beyond mere automation of human tasks.

Because the server converts unstructured user input into category-specific prompt sentences based on a defined template set and classification procedure, the generative AI model receives more constrained and well-structured instructions. This reduces variance in output structure, thereby lowering the amount of computationally expensive post-processing and regeneration. The server's use of structured draft answer data and versioned expert corrections enables efficient database operations and eliminates the need to store multiple unstructured document copies. The centralized processing history allows the server to reuse prior prompt sentences and model configurations, which can reduce repeated experimentation and shorten response time for similar consultations.

The server also optimizes network communication with the external information processing service by sending compact, category-tailored prompt sentences instead of long, unstructured user narratives. Because the server performs pre-processing to extract salient details and remove unnecessary information, the length of the prompt sentence is controlled, which can reduce bandwidth usage and the number of tokens processed by the generative AI model.

This leads to lower latency and improved throughput, particularly when multiple inquiries are processed concurrently. Furthermore, by embedding model parameters and usage statistics in the processing history, the server can adaptively choose decoding parameters that achieve a desired balance between diversity and determinism, thereby improving consistency and reducing the need for multiple regenerations of answers.

In another embodiment, the server supports multiple variants of generative AI models and can select among them based on resource constraints, requested detail level, or category. For example, the server may use a smaller, lower-latency model for routine inquiries and a larger, more capable model for complex strategic questions. The server stores configuration rules that map categories and consultation lengths to model choices and parameter sets. By automatically routing requests according to these rules, the server improves overall computational efficiency and maintains acceptable response times, which constitutes a technical improvement in resource management.

The server can also implement alternative emotion analysis methods. In one variant, the server relies on a rule-based sentiment lexicon tailored to business communication, and computes sentiment scores by counting occurrences of words associated with positive or negative sentiment, weighted by part-of-speech tags. In another variant, the server applies a transformer-based language model fine-tuned on sentiment classification tasks, with a softmax output layer providing probabilities for multiple emotion classes. The server can combine outputs from both methods to achieve higher accuracy and robustness. These variations allow the system to flexibly adapt to different deployment environments and requirements while maintaining the core architecture defined by the claims.

The terminal and the user cooperate with the server in a way that exploits these technical improvements. The terminal does not need to implement heavy processing logic; instead, it mainly renders user interfaces and transmits data. Because the server handles categorization, prompt construction, and post-processing on the server side, the system centralizes complex computations where database access and model configuration are available. The user experiences reduced input complexity because the server accepts free-form text while still generating structured, high-quality responses. This division of labor contributes to improved overall system performance and maintainability.

In summary, the server, terminal, and user interact so that the server: (i) maintains structured data representations for consultations and answers, (ii) constructs and records prompt sentences tailored to a generative AI model, (iii) invokes a transformer-based generative AI model in a controlled manner, (iv) performs formatting, safety, and structuring processing on the generated answer text, (v) integrates expert corrections into versioned data structures, (vi) optionally performs emotion analysis to adjust presentation, and (vii) provides the user with a traceable analysis report. By implementing these features in combination, the system improves technical aspects of data processing, communication, storage, and model utilization, and thereby provides a concrete technical solution that goes beyond abstract business logic and enhances the functioning of the underlying computer technology.

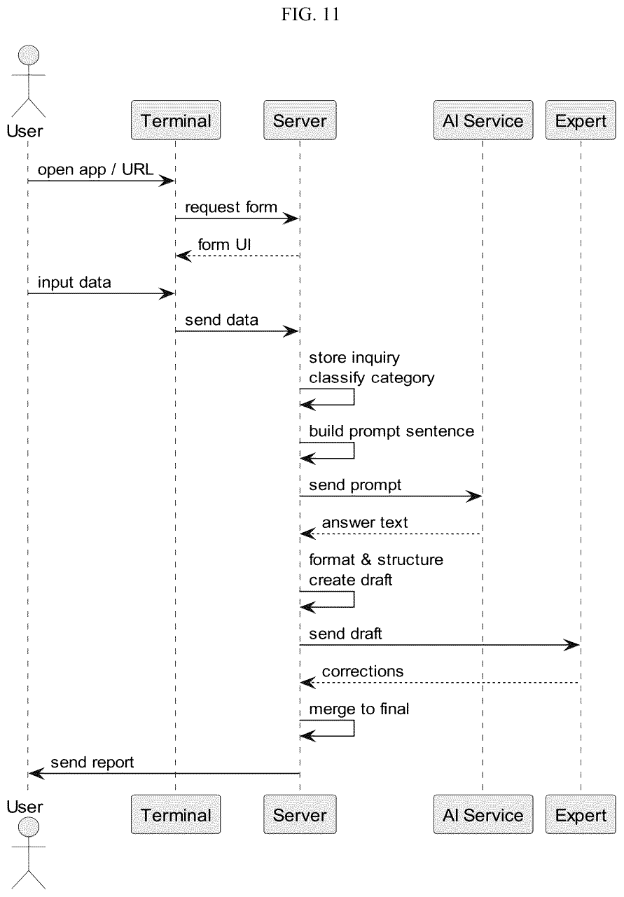

The following describes the processing flow using FIG. 11.

### Step 1

User operates the terminal to launch a web browser or client application and navigates to a network address of the server. The input is a user action specifying a uniform resource locator or selecting an application menu. The output is a request message from the terminal to the server for an information input screen.

### Step 2

Server receives the request for the information input screen from the terminal via a communication network. The input is an HTTP or similar protocol request. The server processes this input by selecting a markup template, cascading style definitions, and client-side script resources from storage. The server combines these resources into a response payload and transmits the payload to the terminal. The output is a rendered-capable description of an information input screen containing fields for organization attribute information, user attribute information, and consultation content information.

### Step 3

Terminal receives the response payload from the server and renders the information input screen using a browser rendering engine. The input is the markup, style, and script data. The terminal parses the markup, applies the styles, executes the scripts, and displays input controls on a display device. The output is a visible form that the user can use to enter text and selections.

### Step 4

User views the displayed input screen and enters organization attribute information, user attribute information, and consultation content information into designated fields. The input is the rendered form interface. The user provides keystrokes and touch or pointer events that fill the fields. The output is populated form data held in the terminal's browser memory.

### Step 5

Terminal collects the populated form data and performs client-side validation. The input is the field values entered by the user. The terminal runs script logic to check required fields, verify formats such as email patterns, and ensure length constraints. If validation passes, the terminal serializes the data into a structured representation, such as a JSON-like object or form-encoded body. The output is a validated, structured dataset ready for transmission.

### Step 6

Terminal transmits the structured dataset to the server as a network request. The input is the validated dataset and a target endpoint address. The terminal encapsulates the dataset into an HTTP or similar protocol request, sets appropriate headers, and sends the request over a transport protocol stack. The output is a network message delivered to the server containing organization attribute information, user attribute information, and consultation content information.

### Step 7

Server receives the network message containing the structured dataset. The input is the request body and headers. The server invokes protocol-handling routines to parse headers, authenticate the user if necessary, and decode the request body into internal data structures. The server maps fields such as organization name, user name, contact information, and consultation text into an application-level record. The output is an internal representation of inquiry data elements in server memory.

### Step 8

Server stores the inquiry data in a database as a persistent record. The input is the internal representation of the inquiry data. The server generates a unique identifier, attaches timestamps, and sets an initial status flag such as “received.” The server issues a database insert operation that writes the record into a table or collection with indexed fields for later retrieval. The output is a stored inquiry record linked to a unique inquiry identifier.

### Step 9

Server performs category estimation on the consultation content information. The input is the textual consultation portion of the inquiry record. The server tokenizes the text into words or subword units, counts term frequencies, and compares tokens against a category mapping table or passes token sequences into a classifier model. The server computes scores for possible industry categories and issue categories, selects one or more categories based on maximum scores or probability thresholds, and updates the inquiry record with the selected categories. The output is an augmented inquiry record containing estimated category information.

### Step 10

Server selects a prompt template based on the estimated categories and constructs a prompt sentence for a generative AI model. The input is the category information, the consultation content information, and stored prompt templates associated with categories. The server retrieves a corresponding template, performs string interpolation or template expansion to insert organization attributes and consultation details, and appends explicit instructions for generating industry analysis information, industry issue information, and initiative information. The output is a complete prompt sentence stored in association with the inquiry identifier.

### Step 11

Server prepares a request to an external information processing service that provides a generative AI model. The input is the prompt sentence and configuration parameters such as model selection, maximum token count, and temperature. The server encapsulates this information in a structured API request payload, sets authentication credentials, and sends the payload over a secure protocol to the external service. The output is a transmitted model invocation request containing the prompt sentence directed to the generative AI model.

### Step 12

Server receives a response from the external information processing service that includes answer text generated by the generative AI model. The input is the API response payload.

The server parses the payload, extracts the answer text field, and records metadata such as model identifier, token usage, and response time. The output is raw answer text stored temporarily in server memory and optionally persisted in a database.

### Step 13

Server performs formatting processing, safety checking processing, and structuring processing on the raw answer text to create draft answer data. The input is the raw answer text. The server scans the text for delimiters or keywords, inserts or normalizes headings such as “Industry Analysis,” “Key Issues,” and “Proposed Initiatives,” and removes or replaces content that matches prohibited patterns according to a safety rule set. The server then segments the text into labeled parts and stores these parts in structured fields within a draft answer record. The output is draft answer data that includes distinct segments for industry analysis information, industry issue information, and initiative information.

### Step 14

Server associates the draft answer data with the corresponding inquiry record and updates the processing status. The input is the draft answer record and the inquiry identifier. The server writes the draft answer data into the database, links it to the inquiry record via the identifier, and sets the inquiry status to a state such as “AI draft created” or “awaiting expert review.”

The output is an updated inquiry record that references the stored draft answer data.

### Step 15

Server transmits the draft answer data and the consultation content information to an evaluator's terminal. The input is the draft answer data, the consultation content information, and evaluator identification. The server composes a message or expert interface view that includes both original consultation text and generated draft sections, and sends this composition over the network to the evaluator's terminal as a web page, application view, or electronic message. The output is a rendered expert review interface on the evaluator's terminal.

### Step 16

Terminal of the evaluator receives and displays the expert review interface. The input is the expert interface payload from the server. The terminal parses markup and script content, renders structured sections of the draft answer data, and presents editing controls such as text areas and buttons. The output is a displayed interface that enables the evaluator to review and modify each segment of the draft answer data.

### Step 17

User acting as an evaluator interacts with the expert interface to review and correct the draft answer data. The input is the displayed industry analysis, industry issues, and initiatives. The evaluator reads the content, compares it with domain knowledge, and performs actions such as editing text, adding explanations, or removing inaccurate portions. The evaluator then submits the corrected content. The output is a modified set of answer segments held in the terminal's memory as correction information.

### Step 18

Terminal of the evaluator transmits the correction information to the server. The input is the edited content and associated identifiers for the inquiry and sections. The terminal serializes this information and sends it as a network request to an expert update endpoint on the server. The output is a network message containing correction information delivered to the server.

### Step 19

Server receives and integrates the correction information into the draft answer data to produce expert-verified final answer data. The input is the correction data and the stored draft answer data. The server performs a merge operation, replacing or updating segments of the draft answer data with evaluator-provided content. The server may compute a diff or patch representation to log specific changes. The output is expert-verified final answer data stored in a final answer record linked to the inquiry identifier.

### Step 20

Server optionally performs emotion analysis processing and adjusts expression content or presentation order of the expert-verified final answer data. The input is the consultation content information, the final answer data, and an emotion analysis function. The server extracts text features, feeds them into the emotion analysis function to obtain emotion tendency information, and applies rule-based adjustments, such as reordering sections or selecting alternate phrasing templates when certain emotion labels are detected. The output is an adjusted version of the final answer data ready for user presentation.

### Step 21

Server organizes the prompt sentence, the answer text, the draft answer data, the expert-verified final answer data, and processing history information into a structured analysis report. The input is all recorded components associated with the inquiry identifier. The server constructs a composite data object that includes narrative text, section headings, timestamps, and model usage metadata arranged in a defined order suitable for document or web presentation. The output is an analysis report structure that can be formatted into message and viewing-screen formats.

### Step 22

Server generates a user-facing representation of the analysis report in a message format or viewing-screen format. The input is the analysis report structure and a target delivery channel such as electronic mail or web interface. The server converts the report into, for example, formatted text with headings for email, or structured markup for a web page. The server embeds or links to the prompt sentence and describes the procedure for using the generative AI model, including an outline of analysis steps. The output is a channel-specific representation of the analysis report.

### Step 23

Server transmits the channel-specific representation of the analysis report to the user via electronic communication means. The input is the formatted report, the user's contact information, and protocol parameters. The server composes and sends an electronic message, or serves a web page in response to a user access request. The output is a delivered report accessible on the user's terminal.

### Step 24

Terminal of the user receives and displays the delivered analysis report. The input is the electronic message or web content from the server. The terminal decodes and renders the content, showing the industry analysis information, industry issue information, initiative information, and a description of the processing history including the prompt sentence and use of the generative AI model. The output is a visible, structured report that the user can read and utilize.

### Step 25

User reviews the displayed analysis report and optionally initiates follow-up actions. The input is the presented report content along with user business needs. The user may decide to apply proposed initiatives, store the report, or submit additional consultation content by following links or using controls provided in the interface. The output is a new user decision or a follow-up consultation that can be re-entered into the system, thereby starting a new cycle of the described processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented consultation support systems that utilize artificial intelligence models typically relay user questions to a model and return the model's output to the user with minimal intermediate processing. Such systems often treat the artificial intelligence model as a black-box question-answering engine and are primarily designed as simple front-ends to generic models. As a result, these systems suffer from several technical limitations.

First, conventional systems lack a structured mechanism in the server architecture for generating and managing prompt sentences that are tailored to specific domains, such as industry analysis and business issue resolution. The absence of a standardized prompt generation and storage pipeline results in inconsistent model behavior, non-reproducible responses, and difficulty in auditing or improving system performance over time. From a computer technology perspective, the server is not effectively using its processing and storage resources to control and track the interaction context with the generative AI model.

Second, known systems generally do not integrate an expert-in-the-loop workflow as a native, stateful component of the server-side processing pipeline. The server typically delivers raw model output directly to the user without transforming the output into structured review data for expert evaluation and modification. This leads to technical issues in managing different versions of responses, associating user attributes, prompts, AI outputs, and expert revisions in a coherent data model, and presenting these associations via the network in an efficient, machine-processable format.

Third, conventional systems do not provide a technically integrated mechanism for combining generative AI outputs with emotion analysis of user-related information to adapt the format or sequence of the final response. Emotion analysis, when present, is often implemented as an independent module or an external service, with no consistent linkage in data structures between user emotion states, AI interaction history, and final answer presentation. Consequently, the server cannot systematically adjust response presentation in a way that is traceable and configurable at the level of stored digital records.

Fourth, existing systems lack a comprehensive history management scheme on the server in which the prompt sentences, inquiry procedures, analysis result information, emotion state information, and final answer information are stored as an interrelated information group in a structured digital format. This limitation impairs the ability of the server to generate machine-readable report data that explains the analysis process and outcome to both users and evaluators through electronic communication platforms or information providing platforms. The technical result is that system maintainability, debuggability, and transparency are reduced, and it becomes difficult to systematically improve prompt design, model usage patterns, and expert workflows.

Accordingly, there is a need for an improved computer-implemented system and server-side processing architecture that: (i) systematically generates, stores, and manages prompt sentences and inquiry data for a generative AI model based on structured user attribute information; (ii) converts AI analysis results into review data for expert editing and final answer generation within a unified stateful workflow; (iii) integrates emotion analysis of user-related information to adapt the presentation of final answers; and (iv) organizes all related information into a structured, machine-processable history that can be communicated over networks as report data. Such improvements address concrete technical problems in how the server manages data flows, data structures, and interactions with remote AI services, thereby enhancing the reliability, traceability, and adaptability of AI-assisted consultation systems.

The specific processing by the specific processing unit 290 of the data processing device 12 in Application Example 1 is realized by the following means.

The present invention provides a server comprising a processor, a storage device, a communication interface, and at least one user terminal interface, the processor being configured to execute instructions that cause the server to receive, via the communication interface, attribute information including an organization identifier, an individual identifier, contact information, and consultation content that a user inputs by operating the user terminal; to store the received attribute information in the storage device in association with a consultation record; to generate, based on the stored attribute information including the consultation content, a prompt sentence as character information for querying a generative AI model, to construct inquiry data including the prompt sentence, and to transmit, via the communication interface, the inquiry data to an external information processing apparatus that provides the generative AI model and to receive, via the communication interface, analysis result information as electronic data from the generative AI model, the analysis result information including at least industry analysis information, industry issue information, and initiative information; to store, in the storage device in association with each other, the analysis result information and the corresponding prompt sentence, to convert the analysis result information into review data that is displayable on a display screen for an evaluator having expert knowledge, and to generate final answer information by modifying the analysis result information in accordance with an edit operation input from the evaluator; to format the final answer information into at least one digital format selected from an electronic mail format and a network-based viewing screen format and to transmit, via the communication interface, the formatted final answer information to the user terminal; to input emotion-related information or response information obtained from the user into an information processing function having emotion analysis capability to estimate emotion state information, and to adjust at least one of an expression format and a presentation order of the final answer information based on the emotion state information; and to manage, as a history in the storage device, an information group including at least an inquiry procedure to the generative AI model, the prompt sentence, the analysis result information, the emotion state information, and the final answer information in association with one another, and to organize the information group into a structured digital format and generate report data configured to report an analysis process and an analysis result to at least one of the user and the evaluator via an electronic communication medium or an information providing platform.

This enables the computer system to improve technical operation of AI-assisted consultation services by providing a structured, stateful server-side workflow that tightly integrates prompt management, generative AI interaction, expert review, emotion-aware presentation control, and history-based reporting, thereby enhancing reliability, reproducibility, and adaptability of responses while efficiently utilizing processing, storage, and communication resources.

The term “processor” refers to a hardware information processing unit, such as a central processing unit or a microprocessor, that executes machine-readable instructions to perform operations including data reception, data storage control, data transformation, and communication control within the system.

The term “storage device” refers to a hardware data retaining unit, such as a magnetic storage apparatus, a solid-state storage apparatus, or a semiconductor memory apparatus, that stores digital information including attribute information, prompt sentences, analysis result information, final answer information, emotion state information, and history information.

The term “communication interface” refers to a hardware and software communication control unit that enables transmission and reception of digital data between the server and external apparatuses, including user terminals, evaluator terminals, and external information processing apparatuses, via a wired network, a wireless network, or a combination thereof.

The term “user terminal” refers to an information processing apparatus operated by a user, such as a mobile communication device, a portable computing device, or a stationary computing device, that is configured to send attribute information to the server and receive final answer information from the server via the communication interface.

The term “attribute information” refers to digital information associated with a consultation, including at least an organization identifier, an individual identifier, contact information, and consultation content that are input by the user through the user terminal.

The term “organization identifier” refers to information that identifies an organization, such as a business entity, an institution, or an association, and may include a name, a code, or other identifying data representing the organization.

The term “individual identifier” refers to information that identifies a human individual associated with a consultation, and may include a name, a code, or another identifying element representing the individual.

The term “contact information” refers to information that is used for communication with an organization or an individual, and may include at least one of an electronic mail address, a telephone number, a network address, or other communication-related data.

The term “consultation content” refers to a natural language description of an issue, a question, or a request for advice provided by the user, which forms the basis for analysis and proposal generation by the generative AI model and the evaluator.

The term “generative AI model” refers to a computer-implemented artificial intelligence model that automatically generates text output, including analysis and proposals, based on input text such as a prompt sentence, using learned parameters of a statistical or neural network model.

The term “prompt sentence” refers to character information constructed by the processor that specifies instructions, context, and constraints for the generative AI model, and that is included in inquiry data transmitted to the external information processing apparatus providing the generative AI model.

The term “inquiry data” refers to electronic data generated by the processor that includes at least the prompt sentence and optionally additional metadata, and that is transmitted to the external information processing apparatus in order to request generation of analysis result information from the generative AI model.

The term “external information processing apparatus” refers to an information processing system located outside the server, such as a remote server or a cloud computing platform, that executes the generative AI model and returns analysis result information in response to inquiry data from the server.

The term “analysis result information” refers to electronic data output by the generative AI model in response to the inquiry data, the data including at least industry analysis information, industry issue information, and initiative information related to the consultation content.

The term “industry analysis information” refers to digital information representing an evaluation or explanation of conditions, trends, or structures within a particular industrial field that are relevant to the consultation content.

The term “industry issue information” refers to digital information representing problems, challenges, or obstacles that are characteristic of or likely to occur within a particular industrial field and that are relevant to the consultation content.

The term “initiative information” refers to digital information representing specific measures, action plans, or strategies intended to address the industry issue information and to respond to the consultation content.

The term “review data” refers to data derived from the analysis result information and formatted by the processor such that it is displayable on a display device for an evaluator, enabling the evaluator to review, edit, or supplement the content.

The term “evaluator” refers to a human operator having specialized knowledge or expertise in a relevant field, who reviews, modifies, and approves the analysis result information to generate final answer information.

The term “final answer information” refers to digital information generated by the processor based on the analysis result information and edits made by the evaluator, and that constitutes the definitive response provided to the user.

The term “digital format” refers to a structured electronic representation of information, including at least an electronic mail format or a network-based viewing screen format, that is configured to be transmitted via the communication interface and displayed on terminals.

The term “emotion-related information” refers to information that is indicative of or associated with a user's emotional state, and may include explicit user input, response patterns, interaction histories, or other data used for emotion analysis.

The term “emotion analysis capability” refers to a function implemented by software or a combination of software and hardware that processes emotion-related information or response information to estimate emotion state information representing a user's emotional condition.

The term “emotion state information” refers to digital information representing an estimated emotional condition of the user, such as satisfaction, dissatisfaction, anxiety, or confidence, which is used by the processor to adjust presentation of the final answer information.

The term “expression format” refers to a presentation style of digital content, including at least text tone, level of detail, structure, or visual layout, which can be adjusted by the processor based on the emotion state information.

The term “presentation order” refers to the sequence in which parts of the final answer information are presented to the user, including the relative ordering of sections such as analysis, issues, and initiatives, which can be altered by the processor based on the emotion state information.

The term “history” refers to accumulated, time-ordered digital records stored in the storage device that include at least inquiry procedures to the generative AI model, prompt sentences, analysis result information, emotion state information, and final answer information associated with each consultation.

The term “information group” refers to a set of related digital elements comprising at least the inquiry procedure to the generative AI model, the prompt sentence, the analysis result information, the emotion state information, and the final answer information that are associated with a particular consultation.

The term “structured digital format” refers to a machine-readable representation of data, such as a record structure, a markup description, or a hierarchical data model, in which elements of the information group are organized with explicit relationships to enable efficient storage, retrieval, and transmission.

The term “report data” refers to digital information generated from the history or the information group that describes at least an analysis process and an analysis result in a form suitable for presentation to a user or an evaluator via an electronic communication medium or an information providing platform.

The term “electronic communication medium” refers to a communication environment for transmitting and receiving digital information, including at least an electronic mail system, a web-based transmission system, or another network-based communication mechanism.

The term “information providing platform” refers to an electronic system, such as a web portal, a dashboard application, or another network-accessible service, that presents structured digital information, including report data and history information, to users and evaluators.

Various embodiments for carrying out the invention are described below. In the following description, a “server” denotes an information processing apparatus including at least a processor, a storage device, and a communication interface. A “terminal” denotes an information processing apparatus operated by a user or an evaluator. A “user” denotes an operator of a physical store or other entity who submits consultation content.

### A. Overall Hardware and Software Configuration

The server uses commercially available hardware, for example a rack-mounted computer equipped with a multi-core central processing unit (CPU), a graphics processing unit (GPU) when required for local model execution, a semiconductor memory as a main memory, and a non-volatile storage device such as a solid-state drive. The server connects to a communication network via a wired or wireless communication interface implementing Internet Protocol.

The server executes an operating system such as a general-purpose server operating system, and runs application software implemented using a server-side framework such as a web application framework. The server also uses a relational database management system such as a relational database engine as the storage device for structured data. The server further uses an application programming interface (API) client library for communication with a generative AI model service, for example a client library corresponding to an external large language model service.

The terminal uses hardware such as a mobile communication device, a portable computing device, or a stationary computing device. The terminal executes an operating system for client devices and runs a web browser or a native application. The terminal displays user interfaces implemented using markup language and script language, and the user operates input devices such as a touchscreen, a keyboard, and a pointing device.

### B. Data Structures and Internal Modules

The server allocates regions in the storage device to maintain structured records. The server stores, for each consultation, at least:
(1) attribute information, including an organization identifier, an individual identifier, contact information, and consultation content;
(2) a prompt sentence associated with the consultation;
(3) inquiry data sent to a generative AI model;
(4) analysis result information received from the generative AI model, including at least industry analysis information, industry issue information, and initiative information;
(5) review data prepared for an evaluator;
(6) final answer information produced after evaluator editing;
(7) emotion-related information and emotion state information; and
(8) history and report data.

The server defines, in the database, multiple logically related tables or collections, including for example a consultation table, a prompt table, an AI_result table, an evaluator_edit table, an emotion_state table, and a history table. Each table uses a primary key and foreign keys to establish one-to-one or one-to-many relations among consultations, prompts, AI outputs, evaluator revisions, and emotion states. This normalized schema allows the processor to retrieve related elements efficiently and prevents inconsistencies arising from duplicated storage.

The server functionally divides the application software into modules, including:
(1) an attribute acquisition module, which controls reception and validation of attribute information from the terminal;
(2) a prompt generation module, which constructs a prompt sentence based on attribute information;
(3) a generative AI interaction module, which formats inquiry data, sends it to the generative AI model, and parses responses;
(4) a review preparation module, which converts analysis result information into review data for an evaluator;
(5) an evaluator integration module, which records edits and generates final answer information;
(6) an emotion analysis integration module, which communicates with an emotion analysis function and receives emotion state information; and
(7) a history management and reporting module, which composes structured histories and report data.

### C. Prompt Generation and Non-Conventional Data Control

The server uses the prompt generation module to transform unstructured consultation content into a structured prompt sentence for a generative AI model. The server does not simply forward the consultation text; instead, the server performs specific data processing operations, including:
(1) the server normalizes the consultation content by converting character encoding into a unified encoding such as UTF-8, removing invalid control characters, and standardizing whitespace;
(2) the server classifies the consultation content into categories, such as “promotion”, “inventory management”, or “staff training”, using a rule-based classifier or a machine learning classifier. The classifier uses features such as term frequency vectors, keyword presence, or embeddings calculated from the consultation text;
(3) the server selects a prompt template based on the classified category. The prompt template is pre-defined and includes fields for industry analysis, issues, and initiatives. Each template specifies explicit headings and numbering rules, such as “1. Industry analysis”, “2. Industry challenges”, and “3. Initiatives”;
(4) the server inserts normalized consultation content and attribute information into the selected template. By doing so, the server generates a prompt sentence that constrains the generative AI model to output structured sections with predictable headings.

For example, when the user provides consultation content related to a new product promotion, the server generates a prompt sentence such as: “You are a professional consultant specializing in brick-and-mortar retail.

A store operator has submitted the following consultation.
Organization: [organization identifier]
Individual: [individual identifier]
Consultation: We want to consult about methods for promoting a new product in our physical store.

Based on up-to-date industry trends and successful examples in similar retail businesses, please output:
1. A clear and concise industry analysis relevant to physical retail promotion,
2. The main industry challenges that a small brick-and-mortar store is likely to face when promoting a new product,
3. At least five specific and practical initiatives for promotion that can be executed with a limited budget,
4. For each initiative, a brief explanation of why it is effective.

Please structure the answer with headings and bullet points so that it is easy for a non-expert store operator to understand.”

The server stores both the selected template identifier and the final prompt sentence in the storage device. This storage allows subsequent retrieval, reproducibility of interactions, and systematic refinement of templates based on feedback. Compared to a system that passes unstructured user input directly to a model, this controlled prompt generation and storage yields more consistent and predictable structured outputs, thereby improving computational efficiency of downstream parsing and display.

### D. Generative AI Model Interaction and Internal Operation

In one embodiment, the generative AI model is a large-scale neural network with a transformer architecture. The model comprises multiple layers of self-attention blocks, feed-forward networks, and normalization operations. The model is trained on large text corpora using a language modeling objective, where the model predicts the next token given preceding tokens. During training, the model minimizes a cross-entropy loss function between predicted token distributions and ground truth tokens, and updates model parameters by gradient-based optimization, such as stochastic gradient descent with adaptive moment estimation. The model uses positional encodings to represent token positions and applies multi-head attention to capture relationships between distant tokens.

The server, via the generative AI interaction module, prepares an input sequence by tokenizing the prompt sentence. Tokenization converts characters into integer token identifiers according to a vocabulary. The server specifies model parameters such as maximum token length and sampling temperature in API parameters. The external information processing apparatus receives these token sequences and processes them through the transformer layers. Each layer computes attention weights based on similarity between query and key representations of tokens, and computes weighted sums of value representations. Layer outputs propagate through feed-forward networks and normalization layers. The model generates output tokens step-by-step, each time using probability distributions over the vocabulary.

The external information processing apparatus then returns the generated sequence as text in structured sections. Because the server enforces a prompt format with explicit headings, the generated text contains recognizable patterns that the server can parse deterministically. This arrangement reduces the need for complex natural language understanding algorithms on the server side, thereby improving processing speed and robustness.

In some embodiments, the server executes a smaller generative AI model locally, for example a distilled transformer model fine-tuned on domain-specific consultation data. In this case, the server loads model parameters into memory and executes matrix multiplication, attention, and non-linear activation operations on a GPU. This local execution reduces network latency and increases throughput for repetitive or less complex consultations.

### E. Expert Review and Structured Editing

The server organizes the analysis result information into review data suitable for an evaluator. The server uses markup or structured tags to indicate sections “industry analysis”, “industry issues”, and “initiatives”. The review preparation module converts plain text from the generative AI model into a structured representation such as a list of section objects stored in the storage device. Each section object includes a section type identifier, a text body, and optional metadata.

The server provides these section objects to the terminal operated by the evaluator, via an application interface. The terminal renders the review data in an editable form, for example by placing each section in a separate text editing field with labels. When the evaluator modifies the content, the terminal sends back the modified text together with identifiers that indicate which section and which consultation are being edited.

The server records each edit as a separate revision record in an evaluator_edit table. Each record includes the previous text, the new text, timestamps, and an evaluator identifier. This granular revision history is a specific, non-conventional data management feature that enables later reconstruction of the evolution of the content and detailed audit of which parts were machine-generated and which parts were altered by a human expert.

By structuring the content into identifiable sections and storing revision metadata, the server improves the internal data management of the consultation system. The server can compute diffs between versions, detect frequently revised patterns, and use such information in future adjustments of prompt templates or training data, thereby providing a technical feedback loop that outperforms a simple human-overwrite approach.

### F. Emotion Analysis Integration and Adaptive Presentation

The server uses the emotion analysis integration module to adjust output presentation in view of emotion-related information. The server can obtain emotion-related information from different sources, such as explicit feedback submitted by the user through rating interfaces, response delays, or linguistic cues in follow-up messages. The server encodes these inputs into numeric features, such as sentiment scores, time intervals, or categorical feedback labels.

The server transmits these features to an emotion analysis function, which may be a classifier model such as a neural network or a gradient-boosted tree model. The model is trained on supervised data where input features are paired with emotion labels such as “frustrated”, “confident”, or “uncertain”. The model uses a loss function, such as cross-entropy loss, and gradient-based learning to optimize its parameters.

The emotion analysis function returns emotion state information, encoded for example as a probability distribution over emotion categories. The server stores this emotion state information in association with the corresponding consultation record. The server then uses deterministic rules to adjust the expression format and presentation order of the final answer information. For example, when the emotion state information indicates high uncertainty, the server places practical step-by-step initiatives at the top of the final answer and increases the level of detail, while summarizing analytical background afterwards. When the emotion state indicates confidence, the server can prioritize concise, high-level analysis.

This rule-based adaptation, parameterized by emotion state information, is not merely human editor behavior; it is a specific computation performed by the server, using emotion model outputs to reorder and reformat data structures in memory. Because the rules operate on structured section objects rather than raw text, the reordering is efficient and does not require reanalysis of content. This design improves the suitability of responses to the user's state while maintaining low computation cost.

### G. History Management, Report Generation, and Technical Effects

The server uses the history management and reporting module to associate the prompt sentence, inquiry data, analysis result information, emotion state information, and final answer information for each consultation. The server generates a structured digital format, for example a hierarchical record in which the consultation record references an ordered list of interactions with the generative AI model, each containing a prompt identifier, a timestamp, and an AI output identifier. The history further includes pointers to emotion state records and evaluator edit records.

The server can serialize this structured history into formats such as structured markup or binary encodings and store it in the storage device. When requested by the user or the evaluator, the server composes report data that explains the consultation process. The report data may include a chronological view of generated prompts, key changes introduced by the evaluator, and any presentation adjustments triggered by emotion state information.

From a technical perspective, this structured history reduces ambiguity in the system's operation. It enables efficient debugging and optimization, because engineers can programmatically search and analyze how prompt designs and emotion-based rules influence final answers. The system thus improves over conventional black-box interactions by making server-side behavior observable and analyzable in a machine-readable form.

This architecture contributes to computer technology improvements in several ways:
(1) Processing speed and efficiency: By enforcing structured prompts and predictable output formats, the server reduces downstream text parsing complexity. Section-based storage and deterministic reordering rules enable fast reconstruction of responses without repeated model inference.
(2) Accuracy and robustness: By integrating expert revisions into the system as structured data, the server can identify systematic model errors and adapt templates or training examples. This feedback mechanism increases the accuracy of subsequent outputs.
(3) Data management: The normalized database schema, revision tracking, and history representation provide a technically improved manner of storing and managing AI interactions compared to unstructured log files. Queries across multiple dimensions (consultation type, prompt template, emotion state) can be executed efficiently.
(4) Communication load: When the server executes a local generative model for certain tasks, the server reduces dependence on remote calls, lowering network latency and bandwidth usage. Even when using remote models, the controlled prompts prevent repeated trial-and-error calls, thus reducing communication load.

### H. Alternative Embodiments and Variations

The server can vary the generative AI model configuration. In one embodiment, the server uses an external large-scale transformer model as described above. In another embodiment, the server uses a hybrid approach, where a smaller local transformer model handles frequent, well-structured consultation types, and the external model is invoked only when classification confidence is low. This switching logic is implemented by the processor and reduces unnecessary calls to high-cost remote services, thereby improving overall system efficiency.

The server can vary the prompt generation strategy. In one embodiment, the server uses rule-based templates; in another embodiment, the server stores historical prompt-output pairs and applies a retrieval-based method to select similar past prompts for reference. The server then modifies the retrieved prompt by substituting new consultation content. This retrieval-and-adaptation approach exploits the structured history to refine prompts dynamically, leading to more reliable outputs without additional training of the generative AI model.

The terminal may vary by type. In one embodiment, the terminal is a mobile communication device; in another embodiment, the terminal is a desktop workstation used by an evaluator. In both cases, the server maintains consistent data formats so that different terminals can participate in the same workflow without modification of the core server logic.

In another embodiment, the emotion analysis function runs locally on the server using a compact neural network trained specifically on past user feedback data. The server regularly retrains this network using accumulated emotion-related records and outcome measures such as acceptance rate or follow-up questions. By periodically updating the model, the server adapts the emotion prediction to changing user populations and interaction patterns.

In yet another embodiment, the server utilizes a rules engine in combination with the generative AI model. The rules engine encodes domain-specific constraints, such as legal compliance constraints or budgetary limitations. After receiving the analysis result information, the server applies the rules to filter, modify, or annotate initiatives. The rules can suppress or flag recommendations that conflict with preset constraints. This hybrid architecture, combining statistical generative modeling with explicit rule-based control, provides a technical mechanism for increasing reliability beyond what a purely human editor or purely model-based system can easily achieve.

Through these embodiments, the server, the terminal, and the user cooperate as part of a technically structured system in which prompt sentences, model interactions, expert revisions, emotion-based adaptations, and history management are interlinked by explicit data structures and algorithms. This configuration provides concrete improvements in how computer systems manage and control interactions with generative AI models, going beyond simple automation of human tasks and contributing to the advancement of computer technology itself.

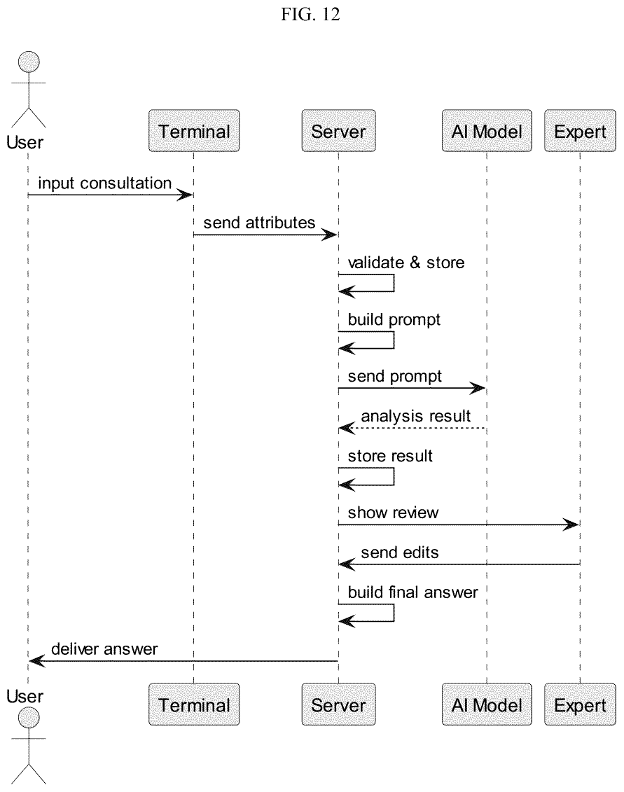

The following describes the processing flow using FIG. 12.

### Step 1

The user operates the terminal to access a consultation input screen provided by the server.

The terminal displays input fields for an organization identifier, an individual identifier, contact information, and consultation content. The user enters text into these fields. The terminal validates the basic format of the input (for example, checks that mandatory fields are not empty and that the contact information contains an email-like pattern) using a script running in the browser or application.

Input: raw keystrokes and touch events from the user.

Output: structured attribute information on the terminal (for example, a set of key-value pairs in memory) ready to be transmitted to the server.

### Step 2

The terminal converts the attribute information into a request message and transmits the request to the server via a network. The terminal constructs an HTTP request body encoded in a structured format and attaches metadata such as a timestamp and a session identifier. The terminal then sends the request over a secure channel.

Input: structured attribute information held by the terminal.

Output: a network message containing the attribute information, which is delivered to the server through the communication interface.

### Step 3

The server receives the network message through the communication interface and parses the request body. The server decodes the structured format, converts it into an internal representation such as an object in memory, and performs server-side validation (for example, regular-expression checking of email and phone number, length checking of text fields, and character-encoding normalization). When validation fails, the server generates an error message and sends it back; when validation succeeds, the server proceeds to registration.

Input: the network message containing the attribute information.

Output: a validated internal data object representing the attribute information, or an error response transmitted back to the terminal.

### Step 4

The server registers the consultation in the storage device. The server opens a transaction with the database, inserts a record into a consultation table including the organization identifier, the individual identifier, the contact information, the consultation content, and a status field set to an initial state. The server obtains a unique consultation identifier assigned by the database and stores this identifier together with the attribute information in memory for subsequent processing.

Input: the validated internal data object representing the attribute information.

Output: a persistent consultation record in the storage device and a consultation identifier that links all subsequent data to this consultation.

### Step 5

The server classifies the consultation content to select an appropriate prompt template. The server applies a classification function that uses either a rules engine (for example, keyword matching) or a lightweight machine learning model. The server computes features from the consultation content, such as frequency of predefined terms and length of sentences, and then determines a category (for example, promotion, cost reduction, or customer management).

Based on the determined category, the server retrieves a corresponding prompt template from a template repository.

Input: consultation content associated with the consultation identifier.

Output: a category label and a selected prompt template reference used for constructing a prompt sentence.

### Step 6

The server generates a prompt sentence tailored to the consultation. The server takes the selected prompt template and replaces placeholder tokens with the actual organization identifier, individual identifier, and consultation content. The server also appends explicit instructions regarding output structure, such as numbered sections for industry analysis, industry issues, and initiatives. The server then creates a complete prompt sentence as a continuous text string.

Input: the prompt template reference, the organization identifier, the individual identifier, and the consultation content.

Output: a constructed prompt sentence stored as character data in memory, associated with the consultation identifier.

### Step 7

The server constructs inquiry data for the generative AI model. The server packages the prompt sentence into a request structure required by the external information processing apparatus, sets parameters such as maximum token length and temperature, and includes the consultation identifier for tracking. The server then serializes this structure into a network message format compatible with the AI service API.

Input: the constructed prompt sentence and configuration parameters for the generative AI model.

Output: formatted inquiry data ready to be transmitted to the external information processing apparatus.

### Step 8

The server transmits the inquiry data to the external information processing apparatus that provides the generative AI model and waits for a response. The server sends the network message over the communication interface using a secure protocol. The external apparatus tokenizes the prompt sentence, processes it through a trained neural network, and generates analysis result information. After the external apparatus finishes processing, it sends a response message back to the server.

Input: inquiry data containing the prompt sentence and model parameters.

Output: a network response message from the external information processing apparatus containing analysis result information in a structured textual form.

### Step 9

The server receives and parses the analysis result information. The server decodes the network response, extracts the text generated by the generative AI model, and identifies logical sections based on headings and numbering that were requested in the prompt sentence. The server splits the text into industry analysis information, industry issue information, and initiative information and assigns type labels to each section.

Input: the network response message containing the generated text.

Output: structured analysis result information composed of labeled section objects in memory, each linked to the consultation identifier.

### Step 10

The server stores the prompt sentence and the structured analysis result information in the storage device. The server writes a record into a prompt table with the consultation identifier and the prompt sentence. The server writes corresponding records into an AI_result table with the consultation identifier, section types, and section texts. The server updates the consultation status to indicate that AI analysis has been completed and that expert review is pending.

Input: the constructed prompt sentence and the structured analysis result information.

Output: persistent records in the storage device representing the prompt and the analysis result information, and an updated consultation status.

### Step 11

The server prepares review data for an evaluator. The server retrieves the analysis result information from the storage device, groups the section objects into an ordered list, and converts them into a format suitable for display and editing, such as a structured document where each section is mapped to an editable field. The server also appends metadata such as the consultation identifier, timestamps, and section labels.

Input: stored analysis result information and associated metadata.

Output: review data containing ordered, labeled sections and metadata, packaged for transmission to an evaluator terminal.

### Step 12

The server transmits the review data to a terminal operated by an evaluator. The server generates a user interface definition (for example, a web page or application view) that includes editable fields populated with the section texts. The server sends this definition and associated data to the evaluator terminal via the communication interface.

Input: the review data in server memory.

Output: a network message that causes the evaluator terminal to display the analysis result information in an editable format.

### Step 13

The terminal operated by the evaluator presents the review data and accepts edits. The terminal receives the user interface definition and renders separate input areas for industry analysis, industry issues, and initiatives. The evaluator reads the content and makes modifications using input devices. The terminal records each change in local memory and, when the evaluator finishes editing, aggregates the modified texts together with section identifiers and the consultation identifier.

Input: review data received from the server and edit operations performed by the evaluator.

Output: edited section data and associated identifiers ready to be sent back to the server.

### Step 14

The terminal transmits the edited content to the server. The terminal creates an update request including the consultation identifier, section identifiers, original text hashes or versions if needed, and the modified texts. The terminal sends this request to the server via the communication interface.

Input: edited section data stored on the evaluator terminal.

Output: a network message containing evaluator edits, delivered to the server.

### Step 15

The server receives the evaluator edits and generates final answer information. The server parses the update request, verifies the consultation identifier and section identifiers, and computes differences between the original and modified texts if version tracking is enabled.

The server then creates revision records in an evaluator_edit table and assembles the latest section texts into a single final answer document in memory.

Input: the network message containing edited section data and identifiers.

Output: updated evaluation records and a composed final answer information object linked to the consultation identifier.

### Step 16

The server stores the final answer information and updates the consultation status. The server writes the final answer document into a final_answer table in the storage device and associates it with the consultation identifier. The server changes the consultation status from expert review pending to completed. The server optionally marks obsolete intermediate versions for archival or deletion, according to system policy.

Input: the composed final answer information object.

Output: a persistent final answer record in the storage device and an updated consultation status indicating completion.

### Step 17

The server acquires or updates emotion-related information and derives emotion state information. The server obtains emotion-related information from user behavior or explicit feedback, such as satisfaction ratings, follow-up messages, or response times. The server transforms these raw inputs into numerical features (for example, sentiment scores and delay intervals) and inputs the features into an emotion analysis function. The function outputs emotion state information, such as probabilities of different emotional categories. The server stores this emotion state information in association with the consultation identifier.

Input: raw emotion-related information and feedback associated with the consultation.

Output: structured emotion state information and stored emotion state records in the storage device.

### Step 18

The server adjusts the expression format and presentation order of the final answer information based on the emotion state information. The server reads the final answer sections from the storage device and reorders or reformats them according to predetermined rules that reference the emotion categories. For example, when the emotion state indicates high uncertainty, the server moves concrete initiatives to the beginning and inserts additional explanatory text; when the emotion state indicates confidence, the server compacts the text and emphasizes summaries.

Input: stored final answer information and emotion state information.

Output: a modified final answer representation in memory, optimized for presentation to the user given the estimated emotional state.

### Step 19

The server formats the final answer information into an output-specific digital format. The server selects an output channel, such as an electronic mail format or a web-based viewing format. The server uses a template engine to embed the final answer sections into an HTML email or a web page layout, adds headers and footers, and encodes the content in a character encoding suitable for transmission.

Input: the modified final answer representation and an output channel selection.

Output: a formatted digital document ready to be sent to the user terminal.

### Step 20

The server transmits the formatted final answer information to the user terminal. The server sends an email through an email server or responds to a web request with the prepared HTML content. The server also records in the history table that the final answer has been delivered, together with a timestamp and delivery method.

Input: the formatted digital document containing the final answer information.

Output: a network message delivered to the user terminal and an updated delivery record in the storage device.

### Step 21

The terminal operated by the user receives and displays the final answer information. The terminal obtains the email or the web page, decodes the content, and presents the sections on the display device, preserving headings, lists, and emphasis as specified by the server. The user reads the final answer and may optionally store it or print it.

Input: the network message containing the formatted final answer information.

Output: a rendered visual representation of the final answer on the terminal display, accessible to the user.

### Step 22

The server records and maintains a structured history of the entire interaction. The server consolidates references to the attribute information, prompt sentence, inquiry data, analysis result information, evaluator edits, final answer information, emotion state information, and delivery events into a single history record linked by the consultation identifier. The server serializes this record into a structured digital format and stores it in the history table in the storage device.

Input: identifiers and references for all data entities produced during the consultation lifecycle.

Output: a consolidated, structured history entry that supports later reporting, analysis, and system optimization.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2.

The units of the system described below are implemented by the data processing device 12 and the smart device 14. The data processing device 12 is called a “server” and the smart device 14 is called a “terminal”.

Conventional computer-implemented business analysis systems typically rely on either static rule-based engines or direct invocation of a generative AI model based solely on a user's free-text query. In such architectures, the processor often forwards the user's query to an AI service without structured integration of up-to-date market data, without explicit management of the relationship among input data, prompts, and AI outputs, and without systematic integration of expert review and user-facing reporting. As a result, the underlying computer system exhibits several technical deficiencies.

First, when the processor does not automatically classify the user's consultation information into a target field and target region and does not automatically determine which market-related information to obtain from external data sources, the system tends to issue unstructured or generic AI requests. This leads to redundant data traffic over communication networks, inefficient utilization of external information providing apparatuses, and inconsistent internal data formats. These factors increase processor load for subsequent processing, impair cache locality and storage efficiency, and make it more difficult for the system to scale across many concurrent consultations.

Second, when the processor merely forwards user text to a generative AI model without embedding normalized, machine-curated market-related information as context in a structured prompt sentence, the AI model often produces responses with incomplete or outdated assumptions. From a computer-technical perspective, this results in repeated iterations of AI queries, unnecessary inference cycles at the AI model, and higher latency in the end-to-end transaction. The absence of a standardized, context-enriched prompt structure also hinders deterministic post-processing and structured storage of the AI output, degrading the system's ability to support reliable downstream processing by other software components.

Third, known systems generally treat the AI-generated output as an opaque text blob, without providing a processor-level mechanism to structurally link consultation information, prompt sentences, market-related information, intermediate AI analysis results, and final edited answers. This lack of relational management at the data model and processing level makes it difficult for the processor to generate traceable, machine-readable report information that explains the AI query procedure and summarizes analysis results. Consequently, the system cannot efficiently support auditability, reproducibility, or automated summarization, which are important for technical interoperability with other computing systems.

Fourth, emotion-related information, when used at all, is often handled at a superficial user interface layer, rather than as a first-class input into the core processing pipeline. Without a processor-configured emotion analysis function that adjusts representation format and presentation order of information in a structured way, the system cannot systematically optimize the layout, sequencing, and level of detail of the analysis result information and final answer information. This can increase user interaction steps, require additional manual filtering or reformatting actions, and thereby reduce the overall efficiency of human-computer interaction at the system level.

Accordingly, there is a need for an improved computer-implemented system in which a processor programmatically (i) classifies consultation information, (ii) acquires and normalizes relevant market-related information from external information sources, (iii) constructs structured, context-enriched prompt sentences for a generative AI model, (iv) stores AI-generated analysis results as structured data, (v) manages explicit relationships among all related data elements, and (vi) optionally incorporates emotion-related information to algorithmically adjust the representation and delivery of the results. Such improvements are required to reduce redundant network calls and processing cycles, to lower latency, to improve data structure consistency and traceability, and to enhance overall system performance and reliability as a computer technology.

The specific processing by the specific processing unit 290 of the data processing device 12 in Example 2 is realized by the following means.

The present invention provides a server comprising a processor configured to receive consultation information input from a user terminal, analyze the consultation information to extract classification information indicating a target field and a target region, determine, based on the classification information, types of market-related information to be obtained from an external information source, access, based on the classification information, an information acquisition interface provided by an external information providing apparatus via a communication network, obtain, as the market-related information, numerical information and text information including market size information, competitive situation information, and growth potential information, normalize the obtained market-related information into a unified format, and store the normalized market-related information in an internal storage area, construct, based on the consultation information and the market-related information, a prompt sentence including instruction content for a generative AI model, embed the market-related information as context information into the prompt sentence, and generate query information that instructs the generative AI model to generate industry analysis information, industry challenge information, and countermeasure information, transmit the query information to the generative AI model, receive, from the generative AI model, analysis result information including the industry analysis information, the industry challenge information, and the countermeasure information automatically generated based on the prompt sentence, and store the received analysis result information as structured data in a storage device, present the analysis result information to an evaluator having expert knowledge, accept correction information and additional information from the evaluator, and verify and edit the analysis result information based on the correction information and the additional information to generate final answer information, manage a relationship among the consultation information, the prompt sentence, the market-related information, the analysis result information, and the final answer information, and generate report information including a procedure of querying the generative AI model and summary content of the analysis result information, and transmit the final answer information and the report information in a digital format to the user terminal or an information browsing service via an electrical communication medium. This enables the server to reduce redundant external data acquisition and AI inference operations by programmatically selecting and normalizing only relevant market-related information, to supply a structured, context-enriched prompt sentence to the generative AI model so as to improve the quality and determinism of AI-generated outputs, to store such outputs as structured data linked to the originating consultation and prompt for efficient retrieval and traceable reporting, and to deliver optimized, machine-generated and expert-refined analysis information to user devices with improved latency, scalability, auditability, and overall computer system performance.

The term “consultation information” refers to information input by a user via a user terminal, the information including a request for analysis, a description of a business situation, or other inquiry content that serves as a basis for subsequent data acquisition, prompt construction, and analysis processing by the system.

The term “user terminal” refers to an information processing apparatus operated by a user, such as a computing device or communication device, that is configured to transmit consultation information to the server and receive final answer information and report information from the server via a communication network.

The term “classification information” refers to information indicating at least a target field and a target region, the information being derived from the consultation information by analysis processing and being used to determine types of market-related information to be obtained from an external information source and to configure subsequent processing by the processor.

The term “target field” refers to a categorized domain or industry segment to which the consultation information pertains, the domain or industry segment being used by the processor as a parameter for acquiring market-related information and generating analysis by the generative AI model.

The term “target region” refers to a geographical area or market area that is relevant to the consultation information, the geographical area or market area being used by the processor as a parameter for acquiring market-related information and for contextualizing analysis results.

The term “market-related information” refers to information related to a market environment, including at least market size information, competitive situation information, and growth potential information, the information being obtained from an external information source and normalized into a unified format for use in constructing a prompt sentence and generating analysis result information.

The term “external information source” refers to an external apparatus, service, or database accessible via a communication network, the external apparatus, service, or database being configured to provide the market-related information or other data through an information acquisition interface.

The term “information acquisition interface” refers to a programmatic interface, such as an application programming interface or data access protocol, provided by the external information source, the interface being configured to receive requests from the server and to return market-related information in response to the requests.

The term “market size information” refers to numerical information and associated descriptive information that indicate a scale of a market, including, for example, values of revenue, volume, or number of customers in a given field and region for a given period.

The term “competitive situation information” refers to numerical information and descriptive information related to a competitive environment in a market, including, for example, information regarding principal participants, market shares, differentiation factors, and competitive dynamics.

The term “growth potential information” refers to numerical information and descriptive information related to a growth outlook of a market, including, for example, information on growth rates, projected trends, and expansion or contraction patterns over a predetermined time period.

The term “normalized market-related information” refers to the market-related information after it has been converted by the processor into a unified internal representation, including standardized data formats, units, and structures, so that the information can be consistently stored, processed, and embedded into prompt sentences.

The term “generative AI model” refers to a machine learning model, such as a language model, configured to generate text or other data based on input prompt information, the model performing inference processing in response to query information sent from the server.

The term “prompt sentence” refers to instruction content formed as a natural language text or structured text, the instruction content specifying a processing objective for the generative AI model, and including at least part of the consultation information and market-related information as context information.

The term “context information” refers to supplemental information, including at least the normalized market-related information, embedded in the prompt sentence to condition or constrain the operation of the generative AI model, thereby guiding generation of industry analysis information, industry challenge information, and countermeasure information.

The term “query information” refers to information transmitted from the server to the generative AI model, the information including the prompt sentence and any associated parameters required for the generative AI model to execute inference and generate analysis result information.

The term “industry analysis information” refers to information generated by the generative AI model or the expert evaluator that describes characteristics of a target market or industry, including, for example, summaries of market size, competitive landscape, and growth potential for the field and region specified by the classification information.

The term “industry challenge information” refers to information generated by the generative AI model or the expert evaluator that identifies problems, barriers, or risks within a target industry or market, the problems, barriers, or risks being derived from the consultation information and the market-related information.

The term “countermeasure information” refers to information generated by the generative AI model or the expert evaluator that proposes actions, strategies, or measures for addressing the industry challenge information, the actions, strategies, or measures being associated with the corresponding challenges.

The term “analysis result information” refers to information output by the generative AI model in response to the query information, the information including at least the industry analysis information, the industry challenge information, and the countermeasure information, and being stored by the processor as structured data.

The term “structured data” refers to data stored in a format having a defined schema or structure, such as records with fields corresponding to consultation information, prompt sentences, market-related information, analysis result information, and final answer information, thereby enabling deterministic retrieval, processing, and cross-referencing.

The term “evaluator having expert knowledge” refers to a human operator or an automated expert module that has domain knowledge relevant to the target field and target region and that is configured to review, verify, and edit the analysis result information to generate the final answer information.

The term “correction information” refers to information supplied by the evaluator indicating modifications, corrections, or replacements to at least a part of the analysis result information.

The term “additional information” refers to information supplied by the evaluator that supplements the analysis result information with further explanations, examples, or recommendations beyond those generated by the generative AI model.

The term “final answer information” refers to information obtained by verifying and editing the analysis result information based on the correction information and the additional information, the information representing an expert-refined response to the consultation information.

The term “relationship management” refers to processing by which the processor maintains and updates associations among multiple categories of information, including at least the consultation information, the prompt sentence, the market-related information, the analysis result information, and the final answer information, so that these categories can be cross-referenced and traced.

The term “report information” refers to information generated by the processor that includes at least a description of a procedure of querying the generative AI model and summary content of the analysis result information, the information being configured for delivery to the user or another system.

The term “emotion-related information” refers to information indicating or estimating an emotional state, preference, or sensitivity of a user, the information being derived from user inputs, interaction patterns, or explicit emotion indicators and being used to adjust representation or presentation of information.

The term “emotion analysis function” refers to a software and/or hardware function executed by the processor that performs emotion estimation processing on at least part of the consultation information or the final answer information, based on the emotion-related information, to determine an appropriate representation format or presentation order.

The term “representation format” refers to a configuration of text or other data presented to the user, including, for example, level of detail, tone, segmentation, emphasis, and layout, the configuration being adjustable in accordance with emotion-related information.

The term “presentation order” refers to a sequence in which sections or elements of the analysis result information and the final answer information are presented to the user, the sequence being adjustable so as to prioritize or de-emphasize particular content based on emotion-related information.

The term “document format” refers to a data format configured for display on an electronic viewing medium, including, for example, a markup-based document, a structured text file, or an equivalent representation that segments information into sections.

The term “data format” refers to an electronic representation of information encoded in a machine-readable structure, such as a record set, hierarchical structure, or serialized data, suitable for processing and display by an electronic system.

The term “electronic viewing medium” refers to a display apparatus or user interface capable of visually presenting document format or data format information to a user, such as a screen of a computing device or a web-based display.

The term “electrical communication medium” refers to a communication path or network over which digital signals are transmitted between the server and the user terminal or other systems, including wired and wireless communication infrastructures.

The term “information browsing service” refers to an electronic service, such as a web-based service or an application service, configured to receive the final answer information and the report information and to present such information to a user through an electronic viewing medium.

The term “information providing network infrastructure” refers to a communication and service environment, including network hardware, protocols, and service components, that is configured to distribute document format or data format information to user terminals or other devices.

The term “identification information” refers to data such as identifiers or keys assigned to sections or elements of information, the data being used to enable mutual referencing among sections in the digital format and to support retrieval and linkage operations.

The term “digital format” refers to an electronic, machine-readable representation of information in which sections or elements are structured and indexed, permitting the information to be transmitted via an electrical communication medium or an information providing network infrastructure and to be mutually referable based on identification information.

In one embodiment, a server, one or more terminals, and a communication network cooperate to implement the claimed system. The server includes at least one processor, a main memory, a non-volatile storage device, and a network interface. The terminals include information processing devices such as personal computers, tablet terminals, or mobile terminals, each having a display, an input interface, and a network interface. The processor of the server executes a program stored in the storage device to realize the functions described below.

The server uses general-purpose hardware, for example a multi-core central processing unit and, in some embodiments, one or more graphics processing units. The server uses system software such as an operating system, a web server, and a database management system. For example, the server uses an operating system, a web server framework such as an HTTP application server, and a relational database management system such as a structured query language (SQL) database. The server further uses a machine learning framework such as a tensor computation library to cooperate with a generative AI model.

The terminal uses a web browser or a dedicated application to transmit consultation information to the server and to receive final answer information and report information from the server. The user operates the terminal to enter a description of a business situation or request for analysis as consultation information. The user, for example, inputs a text such as: “Please analyze the potential of a new subscription-based software-as-a-service business for mid-sized logistics companies in a specified country.”

The server stores the consultation information in a storage device as structured records. The server associates the consultation information with a consultation identifier and with user-related metadata. The server uses a data structure in which a consultation table stores a primary key, a user identifier, a text field for consultation content, and fields for classification information, market-related information, and links to analysis result information and final answer information. The server uses a separate table or data structure to store prompt sentences, analysis result information, and final answer information, and uses foreign keys or equivalent linkage fields to manage relationships among these tables. This explicit relational structure enables the server to avoid ambiguous text-only logs and to maintain traceability and reproducibility of AI queries.

The server analyzes the consultation information to derive classification information. The server, for example, uses natural language processing software components built on a language processing library to perform tokenization, part-of-speech tagging, and named entity recognition on the consultation text. The server extracts domain-related terms and location-related terms to determine a target field and a target region. The server maps the extracted terms to normalized codes stored in a classification table. For example, the server maps “logistics” to an industry code and maps a specific country name to a region code. This mapping enables the server to generate machine-readable parameters that are used in later stages to query external information sources. Because the mapping is performed by discrete classification modules and cached in normalized form, the server reduces repeated parsing overhead in later processing stages and improves memory locality when retrieving classification information.

The server accesses external information sources through a communication network to obtain market-related information. The server uses a network interface and an HTTP client library to send structured requests, including industry codes and region codes, to one or more external information providing apparatuses, such as market data servers or report services. The server receives responses in a structured data format such as JavaScript Object Notation or comma-separated values. The server parses the responses using parsers provided by a programming language runtime and converts the parsed data into normalized internal records. For example, the server converts all monetary values to a uniform currency and scale, converts dates to a standard format, and converts lists of competitors into normalized identifiers. The server stores this normalized market-related information in a dedicated market data table, linked to the classification information and consultation identifier.

The server constructs a prompt sentence for a generative AI model by combining the consultation information, the classification information, and the normalized market-related information. The server performs string concatenation and template substitution to embed the market-related information as context information within the prompt sentence. The server uses a prompt template that explicitly structures the instructions to the generative AI model.

For example, the server generates a prompt sentence such as:

“You are an expert business analyst. Based on the following consultation, perform an industry analysis, identify key industry challenges, and propose concrete countermeasures.

### Consultation:

‘Please analyze the potential of a new subscription-based software-as-a-service business for mid-sized logistics companies in a specified country.’

### Context:

The current market size for logistics information technology solutions in the specified country is approximately a certain amount in a recent year. The expected compound annual growth rate over the next five years is about a certain percentage. Major competitors include several representative companies.

### Output Structure:

1. Market Analysis
2. Industry Challenges
3. Recommended Initiatives.”

The server, by embedding machine-normalized values (such as market size and growth rates) explicitly in the context part of the prompt sentence, constrains the generative AI model to operate under consistent numerical assumptions, and thereby reduces the need for repeated model calls to correct assumptions. This design leads to improved processing efficiency and lower network load between the server and the generative AI service.

The server uses a generative AI model implemented as a neural network. The generative AI model is realized, for example, as a transformer-based language model trained on a large corpus of text data. The model includes multiple layers of self-attention and feed-forward networks. Each layer includes weight matrices that have been learned by gradient-based optimization. During training, the model receives tokenized sequences of text and predicts subsequent tokens using a softmax output layer. An objective function such as cross-entropy loss is used to evaluate the difference between predicted tokens and actual tokens. The model adjusts its weight parameters by backpropagating the gradient of the objective function and applying an optimization algorithm such as stochastic gradient descent with adaptive learning rates. The training process may include regularization techniques, dropout, and data augmentation such as random masking or shuffling of input sequences to improve generalization.

The server uses an inference stage of the generative AI model. The server converts the prompt sentence into a sequence of tokens using a tokenization scheme, such as byte-pair encoding or another subword segmentation method. The generative AI model receives the token sequence, embeds the tokens into high-dimensional vectors, and processes them through multiple transformer layers. Each transformer layer computes attention scores over previous tokens and produces context-aware representations. The model then generates output tokens step by step, conditioned on the prompt sentence. The server receives the output tokens and decodes them into natural language text as analysis result information.

Because the generative AI model has been pre-trained and optionally fine-tuned on domain-relevant data, the model can generate structured analysis that aligns with the template specified in the prompt sentence.

The server uses a predetermined set of parameters for the generative AI model at inference time, such as temperature, top-k or top-p sampling thresholds, maximum output length, and penalties for repetition. By selecting these parameters based on the configuration for the target field and target region, the server achieves a trade-off between diversity and determinism. For example, the server sets a lower temperature and a moderate repetition penalty to produce outputs that are both concise and consistent across calls for similar consultations, improving predictability and reducing the need for human rewriting. This parameter control is performed at the server side and results in a measurable reduction of variance in model outputs, simplifying subsequent parsing and storage.

The server stores the analysis result information in structured form. The server parses the generated text using pattern recognition methods such as regular expressions and heading detection. The server splits the text into sections corresponding to “Market Analysis,” “Industry Challenges,” and “Recommended Initiatives.” The server maps each section to dedicated fields within an analysis result table. The server additionally records the prompt sentence and the model configuration parameters used in generating the analysis result information. Thus, each record of the analysis result table contains references to the consultation identifier, the prompt identifier, the classification information, the market-related information identifier, and the final answer identifier. This structured data model provides a technical improvement over unstructured logging by enabling efficient indexed queries and by allowing downstream systems to query for analysis results by any of these keys without reprocessing raw texts.

The server presents the analysis result information to an evaluator via a web-based interface or another information browsing service. The terminal operated by the evaluator displays the analysis result information in separate sections, using a structured layout generated by the server. The evaluator can modify or supplement each section. For example, the evaluator can correct an assumption about the market penetration rate in the “Market Analysis” section or add an additional risk factor in the “Industry Challenges” section. The server receives and stores the corrections and additions as correction information and additional information, linking them to the original analysis result information. The server then generates final answer information by merging the original analysis and the evaluator's modifications according to a rule set. The server, for example, replaces any section that has been edited by the evaluator and adds annotations or version indicators to record the changes.

The server manages relationships among consultation information, prompt sentences, market-related information, analysis result information, and final answer information using a relationship management module. This module maintains mapping tables that record, for each consultation, which prompt sentence was used, which external data sources were accessed, what version of the generative AI model was invoked, and what sequence of modifications was applied by the evaluator. By organizing this information with unique identifiers, the server can reconstruct a full path from an initial consultation to a delivered final answer, including the data sources and model configurations. This relational management enables the server to generate report information that is machine-readable and suitable for audit and review. The server uses this structured history information to avoid repeated calls to the generative AI model when an existing analysis can be reused, thereby reducing computational load and network traffic.

The server optionally uses emotion-related information to modify the representation format and presentation order of analysis result information and final answer information. The server obtains emotion-related information by analyzing user interaction history or responses to specific questions using an emotion analysis function. This function may use a classifier model implemented as a neural network, trained on labeled examples of user texts or behaviors associated with emotional states such as cautious, urgent, optimistic, or skeptical.

The classifier may use features such as lexical patterns, sentence length, use of intensifiers, and historical selection of content. The classifier outputs a probability distribution over emotion categories. The server selects a representation format based on this distribution. For example, if the probability of “cautious” is high, the server selects a format that emphasizes risk descriptions and adds explicit caveats at the beginning of the output. If the probability of “urgent” is high, the server changes the presentation order to present concise action points at the beginning and delays long explanations. This targeted adaptation reduces the number of interactions required for the user to identify relevant information and thus improves the efficiency of human-computer interaction at the system level.

The server converts the consultation information, market-related information, prompt sentences, analysis result information, final answer information, and emotion-related information into document format and data format suitable for display and exchange. The server, for example, generates a structured document with sections corresponding to each information type and with hyperlinks or cross-references based on identification information.

The server may also generate a machine-readable representation such as a hierarchical data structure with section identifiers, titles, and content fields. The server transmits these digital formats via an electrical communication medium to terminals or to an information browsing service. Because the server organizes the data at the section level and assigns identifiers to each section, other components, such as reporting tools or analytic engines, can selectively retrieve and reuse particular sections without processing entire documents. This sectionalization improves data management and allows partial updates without regenerating entire reports.

The terminal receives and displays the final answer information and report information. The terminal uses a rendering engine within a browser or application to present the structured document or data. The user operates the terminal to view the sequence of steps used by the server to query the generative AI model, to view a summary of the analysis result information, and to review the final answer information. The user can also provide additional feedback, which the server may record for further tuning of the system or for retraining of the emotion analysis function.

The system as implemented in the server, terminals, and network yields technical effects beyond mere automation of human reasoning. The server, by programmatically classifying consultation information, selecting relevant market-related information, and embedding that information into a structured prompt sentence, reduces the volume of non-essential data transmitted to external information sources and the generative AI model. This reduction decreases network bandwidth usage and shortens round-trip times. The server, by storing AI outputs as structured data tied to explicit metadata and identifiers, improves retrieval efficiency and reduces redundant computation for subsequent similar consultations. The data structures and relational management permit indexed database queries that are executed in sublinear time relative to the total number of consultations, thereby improving scalability.

The use of a generative AI model with controlled prompt sentences and fixed output structures improves the determinism and parseability of generated texts. Because the server constrains the model with context information and output structure instructions, the server can reliably parse model outputs into predefined fields without complex or fragile natural language parsing. This design reduces parsing errors and reduces the need for manual corrections. At the same time, the emotion analysis function customizes presentation in a way that reduces user-side processing steps, since the most relevant sections are automatically highlighted or reordered.

In another embodiment, the server uses different generative AI models depending on the classification information. For example, the server may select a first model fine-tuned for manufacturing industries and a second model fine-tuned for service industries. The server maintains model configuration records that associate industry codes and region codes with model identifiers and parameter sets. When the server receives consultation information classified as relating to a particular field, the server looks up a corresponding model identifier and parameter set in a configuration table and uses those to construct the query information.

This modular configuration permits the server to deploy specialized models while maintaining a single unified prompt management framework.

In another embodiment, the server performs additional preprocessing on market-related information before embedding it into the prompt sentence. The server may apply statistical smoothing, outlier detection, or time-series forecasting algorithms to raw market data. For instance, the server may compute a smoothed growth curve using an exponential moving average and generate context text based on that curve rather than raw year-by-year values.

This preprocessing reduces noise in the data presented to the generative AI model and leads to more stable outputs. The server can apply these preprocessing steps using numeric computation libraries, with all intermediate values stored in the internal storage for reference and debugging.

In a further embodiment, the server logs performance metrics of the generative AI model and the overall pipeline, such as latency from receipt of consultation information to delivery of final answer information, frequency of evaluator corrections, and average size of generated outputs. The server analyzes these metrics to adjust its parameters, such as prompt templates, model selection, and preprocessing settings. By integrating this feedback loop, the system gradually reduces average processing time and improves accuracy of generated analysis, thereby providing an iterative improvement of the underlying computer technology.

Through these configurations and variations, the server, the terminals, and the network components cooperate in a concrete and technically structured manner to execute the system, and the described data structures, model configurations, and processing flows collectively yield improvements in processing speed, resource utilization, and reliability of computer-based industry analysis, beyond a mere abstract idea or a simple automation of human judgment.

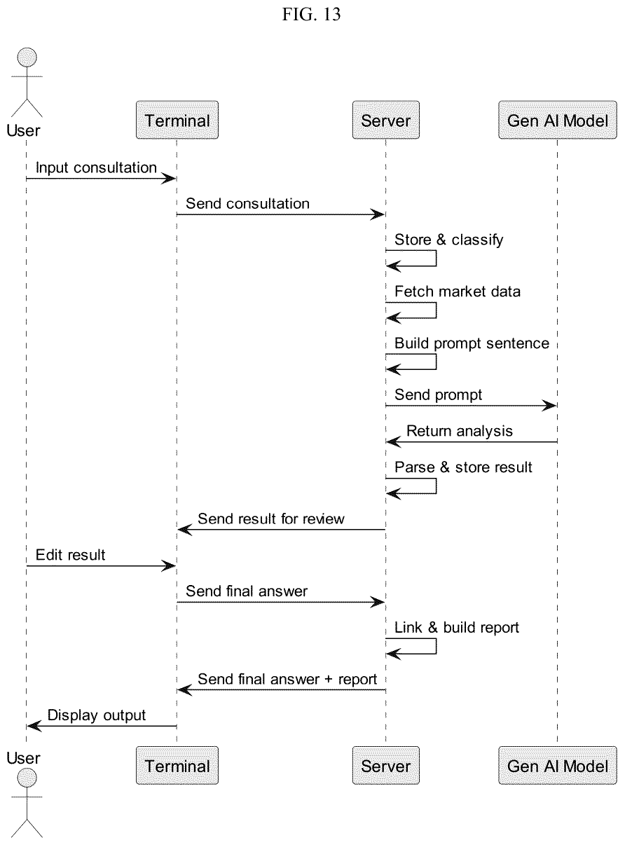

The following describes the processing flow using FIG. 13.

### Step 1

User operates the Terminal to launch a browser or dedicated application and opens a consultation input screen provided by the Server.

Terminal displays an input form including at least a text field for consultation information.

Input: User's keystrokes or touch operations representing a business question or consultation text.

Processing: Terminal converts UI events into a text string in the form of consultation information.

Output: Consultation information text held in the Terminal's memory and ready to be transmitted to the Server.

### Step 2

User confirms the entered consultation information and activates a submission control (for example, a “Submit” button) on the Terminal.

Terminal packages the consultation information into a request message, including a user identifier and timestamp, and sends the message to the Server over a communication network using a predefined protocol.

Input: Consultation information text, user identifier, timestamp.

Processing: Terminal serializes the consultation information into a machine-readable format, attaches metadata, and transmits the serialized data as an HTTP request or equivalent to the Server.

Output: Network request containing consultation information delivered to the Server.

### Step 3

Server receives the network request via a network interface and parses the request body to extract the consultation information and associated metadata.

Server validates the consultation information, for example by checking non-empty content, character set, and maximum length constraints.

Input: Serialized consultation information and metadata from the Terminal.

Processing: Server deserializes the request, performs syntax and validity checks, and discards or flags malformed content.

Output: Validated consultation information object stored in the Server's working memory.

### Step 4

Server stores the validated consultation information into a persistent storage device using a structured data model.

Server assigns a consultation identifier and creates a record linking the consultation identifier with the user identifier, timestamp, and initial processing status.

Input: Validated consultation information object and user metadata.

Processing: Server generates a unique identifier, constructs a database record with predefined fields, and writes the record into a consultation table.

Output: Stored consultation record associated with a consultation identifier.

### Step 5

Server analyzes the consultation information to derive classification information indicating at least a target field and a target region.

Server uses a language processing module to tokenize the text, identify key terms, and map those terms to normalized codes stored in a classification table.

Input: Consultation information text from the consultation record.

Processing: Server applies tokenization, part-of-speech tagging, and entity recognition, then performs a lookup in mapping tables to convert detected words into field codes and region codes.

Output: Classification information object containing target field code and target region code linked to the consultation identifier.

### Step 6

Server determines types of market-related information to be obtained from external information sources based on the classification information.

Server consults a configuration table that maps combinations of field codes and region codes to required market data categories.

Input: Classification information object (target field code and target region code).

Processing: Server performs a key-based lookup in the configuration data, selecting a list of market-related information types such as market size, competitive situation, and growth potential.

Output: Market information request specification indicating which data fields and ranges must be retrieved.

### Step 7

Server accesses one or more external information sources via the communication network using the market information request specification.

Server constructs request messages, including industry codes, region codes, and time periods, and sends them to external information providing apparatuses through defined information acquisition interfaces.

Input: Market information request specification, including field and region codes.

Processing: Server formats API or query requests according to each external interface specification and transmits the requests over the network.

Output: Outgoing network requests aimed at external information sources.

### Step 8

Server receives response messages from the external information sources, each containing raw market-related information.

Server parses the received data, which may be in formats such as JSON or CSV, extracting numerical fields and descriptive text fields.

Input: Raw response payloads from external information sources.

Processing: Server runs parsers to decode the payloads, converts string-encoded numbers to numeric types, normalizes date formats, and matches each piece of data to internal schema fields.

Output: Parsed market-related information records in a preliminary internal representation.

### Step 9

Server normalizes the parsed market-related information into a unified internal format.

Server converts currencies to a standard unit, adjusts scales (for example, millions to base units), and harmonizes category labels according to internal dictionaries.

Input: Parsed market-related information records.

Processing: Server performs numeric transformations (multiplication, division, rounding), applies unit conversion tables, and standardizes text labels using mapping rules.

Output: Normalized market-related information objects stored in a market data table and linked to the consultation identifier and classification information.

### Step 10

Server constructs a base prompt sentence for a generative AI model using the consultation information and the classification information.

Server inserts the consultation text into a pre-defined template that includes instructions such as required analysis sections and output format.

Input: Consultation information text and classification information (field and region).

Processing: Server performs string substitution and concatenation, creating a coherent instruction text that references the target field and target region.

Output: Base prompt sentence stored as a prompt object associated with the consultation identifier.

### Step 11

Server embeds the normalized market-related information as context information into the base prompt sentence.

Server converts key numeric values and descriptive elements into readable phrases and appends them to the prompt under a context section.

Input: Base prompt sentence and normalized market-related information objects.

Processing: Server formats numeric values into text with units, assembles competitor lists, and inserts this formatted text into the context portion of the prompt, maintaining a clear section structure.

Output: Final prompt sentence containing instruction content and embedded context information.

### Step 12

Server generates query information for the generative AI model based on the final prompt sentence and model configuration parameters.

Server creates a data structure that includes the prompt sentence, selected model identifier, and inference parameters such as maximum token count and sampling settings.

Input: Final prompt sentence and stored model configuration data.

Processing: Server packs the prompt and parameters into an inference request structure compatible with the generative AI model's interface.

Output: Query information object ready for transmission to the generative AI model.

### Step 13

Server transmits the query information to the generative AI model through a model interface, which may be a local inference service or a remote AI service accessed via network.

Server sends the tokenized or raw prompt sentence together with configuration parameters, and initiates inference.

Input: Query information object including the final prompt sentence and parameters.

Processing: Server encodes the prompt as required (for example, tokenization or JSON packaging), establishes a connection to the model endpoint, and transmits the query payload.

Output: Inference request delivered to the generative AI model.

### Step 14

Server receives generated output tokens or text from the generative AI model as analysis result information.

Server decodes tokens into text if necessary and reconstructs the full response as a continuous string.

Input: Model response payload containing generated tokens or text segments.

Processing: Server applies decoding algorithms to convert tokens back into characters, concatenates segments, and normalizes line breaks and section headings.

Output: Raw analysis result information text associated with the query and consultation identifiers.

### Step 15

Server parses the analysis result information and separates it into structured sections such as industry analysis information, industry challenge information, and countermeasure information.

Server uses pattern matching on headings and markers specified in the prompt sentence to identify boundaries between sections.

Input: Raw analysis result information text.

Processing: Server detects predefined headings, splits the text at those positions, labels each fragment according to the corresponding section name, and trims extraneous whitespace.

Output: Structured analysis result fields stored in an analysis result data structure.

### Step 16

Server stores the structured analysis result information in a storage device as structured data.

Server creates a record in an analysis result table and links it to the consultation identifier, the prompt identifier, and the market-related information identifiers.

Input: Structured analysis result fields and linkage identifiers.

Processing: Server composes a database record with fields for each analysis section and metadata, then writes the record into persistent storage.

Output: Persistently stored analysis result record accessible for later review and reporting.

### Step 17

Server prepares an evaluator review package that combines the consultation information, final prompt sentence, market-related information summary, and analysis result information.

Server generates a layout specification or document template for display on a Terminal operated by an evaluator.

Input: Consultation record, prompt object, normalized market data, and analysis result record.

Processing: Server merges text fields into a structured view model with labeled sections suitable for human review.

Output: Review package data transmitted or ready to be transmitted to the evaluator's Terminal.

### Step 18

Terminal used by the evaluator receives the review package data from the Server and renders it on a display.

Terminal presents editable fields for each section of the analysis result information.

Input: Review package data from the Server.

Processing: Terminal interprets layout instructions, creates graphical components, and populates them with received text content.

Output: Interactive review screen shown to the evaluator.

### Step 19

User acting as an evaluator reads the displayed sections and enters correction information and additional information into the editable fields using the Terminal.

Terminal records changes made to each section, including insertions, deletions, and replacements.

Input: Original analysis result text and evaluator's editing actions.

Processing: Terminal updates local text buffers to reflect evaluator edits and marks edited sections with flags or version markers.

Output: Modified analysis content and metadata representing correction information and additional information.

### Step 20

User operating the Terminal submits the edited content to the Server as final answer information candidate.

Terminal packages the edited sections and associated identifiers into an update request and transmits it to the Server.

Input: Modified analysis content and section-level edit metadata.

Processing: Terminal serializes the edited content into a structured request and sends it over the network to the Server.

Output: Network request containing candidate final answer information delivered to the Server.

### Step 21

Server receives the edited content from the evaluator and verifies consistency with the existing analysis result record.

Server merges the edited sections with the original analysis sections according to predefined merge rules to create final answer information.

Input: Original analysis result record and evaluator-submitted edited sections.

Processing: Server replaces or augments original sections with edited content, updates status flags, and generates a new record representing final answer information.

Output: Final answer information record stored in a dedicated table or associated with the consultation identifier.

### Step 22

Server manages relationships among consultation information, prompt sentences, market-related information, analysis result information, and final answer information by updating relationship tables or linkage fields.

Server ensures that each piece of information can be traced back through its processing chain.

Input: Updated final answer record and existing linkage metadata.

Processing: Server updates foreign keys or reference lists in the database, registers version numbers, and records timestamps for each stage.

Output: Consistent relational graph of all processing artifacts for the consultation.

### Step 23

Server generates report information describing the procedure of querying the generative AI model and summarizing the analysis result information.

Server extracts key steps, such as which external sources were used, which prompt sentence was sent, which model configuration was applied, and what main conclusions were reached.

Input: Relationship graph, prompt record, market data record, analysis result record, and final answer record.

Processing: Server composes a narrative summary and structured metadata describing the full processing pipeline and converts it into a report text.

Output: Report information text linked to the consultation and final answer records.

### Step 24

Server formats the final answer information and report information for delivery to the user terminal or an information browsing service.

Server converts internal structured records into document format or data format with defined sections and identifiers.

Input: Final answer information and report information.

Processing: Server applies a document template, inserts section headings and content, adds cross-references based on identification information, and serializes the result into a transmissible form.

Output: Delivery-ready document or data payload containing the final answer and report.

### Step 25

Server transmits the formatted final answer information and report information over an electrical communication medium to the user terminal or to an information browsing service.

Server uses a communication protocol such as email, web response, or message push depending on configuration.

Input: Delivery-ready document or data payload.

Processing: Server addresses the payload to the intended recipient, initiates transmission over the network, and logs delivery status in storage.

Output: Transmitted final answer and report information accessible at the user terminal.

### Step 26

Terminal used by the User receives the final answer information and report information from the Server and renders the content on a display.

User views the analysis results, the described AI query procedure, and the expert-refined recommendations via the Terminal.

Input: Received document or data payload from the Server.

Processing: Terminal decodes and displays the content, organizes it into sections, and allows the user to scroll and navigate.

Output: Visual presentation of final answer information and report information to the User.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented advisory systems that rely on generative AI models suffer from several technical shortcomings in how they generate, manage, and deliver analysis results.

First, typical systems send a single, manually composed prompt to a generative AI model and immediately return the raw output to the user. Such systems do not systematically convert heterogeneous user inputs (free text, numerical values, logs) into normalized structured data prior to prompt generation. As a consequence, the generative AI model receives poorly organized context, which degrades the consistency, reproducibility, and precision of the generated output, and increases the computational overhead for repeated or expanded queries.

Second, conventional systems do not integrate emotion analysis in a structured, machine-level feedback loop that can programmatically alter subsequent prompts or post-processing.

Emotion information, when used at all, is generally handled at the presentation layer (for example, by simple style rules in a user interface), without being incorporated into the prompt sentences or into the generation logic of the analysis content itself. This results in suboptimal alignment of tone, depth, and structure of explanations with the user's actual emotional state and comprehension needs, and can lead to user confusion or mistrust of the AI output.

Third, known systems rarely provide a machine-readable, end-to-end processing history that ties together: (i) the prompt sentences, (ii) the raw analysis results from the generative AI model, (iii) the emotion analysis results, (iv) the corrected analysis information, and (v) expert edits. Without such structured history, it is technically difficult to audit model behavior, reproduce prior results, automatically tune prompt templates, or perform systematic error analysis and debugging of the AI pipeline. This lack of traceability also makes it harder to implement automated quality control or to adapt system behavior based on historical performance metrics.

Fourth, existing architectures often rely on ad hoc orchestration logic spread across client and server components. For example, the user terminal might assemble prompts, while the server simply relays them to a generative AI model. This fragmented design complicates optimization of resource usage on the server side, hinders centralized caching and reuse of intermediate results (such as structured data and corrected analysis information), and increases latency because each component needs to maintain its own partial state.

Accordingly, there is a need for an improved computer-implemented system and associated server that: (1) programmatically transforms user information into structured data and uses it to generate consistent prompt sentences for a generative AI model; (2) incorporates emotion analysis results into a closed-loop adjustment of prompts and generated content; (3) centralizes orchestration of multiple rounds of interaction with the generative AI model and emotion analysis apparatus on the server; and (4) records a machine-readable processing history that can be transmitted as report data. Such a system should technically improve the way computing resources are used for multi-stage AI analysis, provide more stable and explainable outputs, and facilitate later auditing and refinement of the AI processing pipeline.

The specific processing by the specific processing unit 290 of the data processing device 12 in Application Example 2 is realized by the following means.

The present invention provides a server comprising a processor and a storage device, the processor being configured to receive user information from a user terminal, convert character information and numerical information included in the user information into structured data, generate first prompt sentences including instruction content for causing an external generative AI model to generate at least one of industry analysis, industry issue information, and action plan information based on the structured data, transmit the first prompt sentences to the external generative AI model via a communication interface, obtain analysis result information from the external generative AI model, generate second prompt sentences including additional input corresponding to emotion information or application domain information associated with the analysis result information, transmit the second prompt sentences to the external generative AI model, obtain corrected analysis information from the external generative AI model, integrate the corrected analysis information and the analysis result information to generate analysis result output information, generate evaluation information including at least a part of the analysis result output information, the first prompt sentences, and a procedure of inquiries to the external generative AI model, transmit the evaluation information to an evaluator terminal and receive correction input from an evaluator via the evaluator terminal to generate final answer information, and organize, in a machine-readable digital format, processing history information including the first prompt sentences, the analysis result information, the corrected analysis information, emotion evaluation information, and the final answer information, and transmit the final answer information, process description information summarizing the procedure of inquiries to the external generative AI model and the analysis result information, and the processing history information as report data to the user terminal via an electronic communication path. This enables centralized, server-side orchestration of multi-stage interactions with the generative AI model and an emotion analysis apparatus, structured and repeatable prompt sentence generation from normalized user data, adaptive adjustment of generated content and explanation tone based on emotion evaluation information, and machine-readable recording and delivery of the complete processing history, thereby technically improving reliability, traceability, and computational efficiency of AI-based analysis and recommendation processing in the computer system.

The term “system” refers to a combination of one or more hardware components and software components that cooperate to execute information processing, including at least a processor, a storage device, and one or more communication interfaces.

The term “processor” refers to a hardware information processing unit, such as a central processing unit or other arithmetic and logic unit, configured to execute instructions stored in a memory to perform data processing and control operations.

The term “storage device” refers to a hardware resource capable of storing data or programs, such as a semiconductor memory, magnetic storage, optical storage, or any non-transitory computer-readable medium.

The term “user terminal” refers to an information processing device used by a user to input information to, and receive information from, the system, such as a personal computer, a mobile communication device, or a network-enabled terminal.

The term “evaluator terminal” refers to an information processing device used by an evaluator to receive evaluation information from the system, provide correction input, and transmit edited information back to the system.

The term “user information” refers to information acquired from a user through a user terminal, including at least character information and numerical information such as profile data, consultation content, transaction records, or operational data.

The term “character information” refers to information expressed as text data composed of characters, symbols, or strings that can be processed as natural language or structured textual content.

The term “numerical information” refers to information represented as one or more numeric values, including integers, real numbers, or coded quantities, such as amounts, counts, time values, or performance metrics.

The term “structured data” refers to data that has been normalized or organized into a predetermined machine-readable format, such as key-value pairs, tabular data, or hierarchical records, enabling programmatic access to individual fields.

The term “prompt sentence” refers to a text sequence that provides explicit instructions, context, or questions to a generative AI model so as to cause the generative AI model to generate a desired analysis result or content.

The term “first prompt sentence” refers to an initial prompt sentence generated from structured data and configured to cause the generative AI model to generate at least one of industry analysis, industry issue information, and action plan information.

The term “second prompt sentence” refers to a subsequent prompt sentence generated based on analysis result information and additional input, including emotion information or application domain information, and configured to cause the generative AI model to generate corrected analysis information.

The term “external generative AI model” refers to an information processing model implemented outside the server, such as a neural network-based generative model, that generates text or other data in response to a given prompt sentence.

The term “analysis result information” refers to output data generated by the generative AI model in response to a first prompt sentence, including at least one of industry analysis, industry issue information, action plan information, or similar analytical content.

The term “corrected analysis information” refers to output data generated by the generative AI model in response to a second prompt sentence, in which analysis result information has been modified, refined, or expanded according to additional input including emotion information or application domain information.

The term “industry analysis result information” refers to information obtained by integrating analysis result information and corrected analysis information, and representing a consolidated analytical output concerning an industry, market, or business environment.

The term “industry issue information” refers to information indicating one or more challenges, risks, or problems present in a particular industry, market segment, or business domain.

The term “action plan information” refers to information describing proposed measures, steps, or strategies for addressing identified issues, implementing improvements, or achieving specific objectives in a business or industry context.

The term “application domain information” refers to information indicating a technical or business field, use case, or scenario category to which the user information or analysis result information pertains.

The term “emotion information” refers to information representing an inferred or evaluated emotional state associated with a user, such as anxiety, confidence, or interest, obtained by an emotion analysis process.

The term “emotion analysis processing apparatus” refers to a hardware and software configuration that receives user-related textual or other data and outputs emotion evaluation information by analyzing affective features within the input.

The term “emotion evaluation information” refers to data output from the emotion analysis processing apparatus indicating one or more emotional states and, optionally, corresponding degrees or scores.

The term “evaluation information” refers to information generated by the processor for presentation to an evaluator, including at least a part of the industry analysis result information, one or more prompt sentences, and at least part of a procedure of inquiries to the generative AI model.

The term “final answer information” refers to information obtained after incorporating evaluator correction input into industry analysis result information, and representing a confirmed or approved response for delivery to the user.

The term “process description information” refers to information summarizing at least a procedure of inquiries to the generative AI model and analysis result information, and optionally including intermediate processing steps or parameters.

The term “processing history information” refers to information that records, in a machine-readable manner, a sequence of processing steps executed by the system, including at least the prompt sentences, analysis result information, corrected analysis information, emotion evaluation information, and final answer information.

The term “report data” refers to data formatted for presentation to the user and including at least part of the processing history information and final answer information, and optionally the process description information.

The term “communication interface” refers to a hardware and software interface that enables the server to transmit and receive data over an electronic communication path or network, including wired or wireless communication.

The term “electronic communication path” refers to a logical or physical path for transmitting digital signals between devices, including one or more networks, communication links, or communication channels.

The term “network-based information providing platform” refers to a server-side or cloud-based infrastructure that provides information, reports, or analysis results to user terminals over a communication network using standardized protocols.

The term “machine-readable digital format” refers to an encoding format for data, such as a structured text, binary, or markup format, that can be parsed and processed by a computing device without human intervention.

In one embodiment, a server, a user terminal, and an evaluator terminal cooperate over a communication network to implement the claimed system. The server includes at least one processor, a main memory, a non-transitory storage device, and a communication interface. The processor is realized, for example, by a multi-core general-purpose processor, and optionally by a graphics processing unit configured for neural network inference. The storage device stores executable programs, configuration data, prompt templates, learned model parameters for auxiliary models, and logs used for processing history information.

The user terminal is implemented by a computing device such as a personal computer, a tablet device, or a mobile communication device equipped with a display unit, an input unit, a memory, and a network communication module. The user terminal executes a web browser or a dedicated application that presents input forms and receives analysis reports from the server. The evaluator terminal is implemented in a similar manner and executes a browser or application that displays evaluation information and allows an evaluator to provide correction input.

The server uses a web application framework, for example a framework for HTTP request handling, to receive user information transmitted from the user terminal. The server stores the raw user information in a relational data store such as a structured query database. The server then converts character information and numerical information included in the user information into structured data. The server performs this conversion by mapping free-form text fields and numeric fields to predefined schema fields, such as “company_profile,” “consultation_text,” “time_series_metric,” and “categorical_label.” The server represents the structured data internally as hierarchical key-value structures, for example as nested records, so that each logical unit (company descriptor, question text, numerical metric array) is addressable by a unique key.

The server uses a natural language processing library, for example a library performing tokenization, part-of-speech tagging, and dependency parsing, to further decompose the consultation text into tokens and syntactic structures. The server extracts domain-related features, such as domain keywords, sentiment polarity, and entities representing industry sectors or product types, and stores these features as part of the structured data. The server also applies normalization to numerical information, such as scaling values to standard ranges and aligning time stamps to a regular time axis, in order to provide consistent numeric representations for subsequent analysis.

The server generates a first prompt sentence from the structured data using a prompt-generation module. The server stores a set of prompt templates in the storage device. Each template corresponds to a particular analysis scenario, such as “industry analysis,” “spending optimization,” or “production efficiency improvement.” The server selects a template according to a scenario label derived from the domain-related features in the structured data.

The server then fills template slots with specific structured data fields by replacing placeholder markers with normalized values.

As a concrete example, when the user information indicates that a corporate user requests an analysis for a new business in an eco-friendly household goods market, the server generates a first prompt sentence such as:

“You are a market analysis assistant.

A company plans to launch a new eco-friendly household products category in a specific national online retail market.

Company profile: mid-sized e-commerce operator with several billion units of annual sales volume.

The user wants to understand market size, competitive landscape, growth potential over the next 3-5 years, and key challenges for launching this new category.

Based on your knowledge, analyze current market size, identify major competitor types, evaluate growth potential, highlight main risks, and propose 3-5 concrete strategies for market entry.”

When the user information indicates that an individual requests advice on spending, the server generates a first prompt sentence such as:

“The user reports difficulty controlling monthly spending and wants practical guidance.

Based on the following description of spending habits and categories, detect overspending patterns, propose a realistic monthly budget, and suggest concrete saving tips that preserve enjoyment of food and hobbies.”

The server sends the first prompt sentence to an external generative AI model through an application programming interface. The generative AI model is, in one embodiment, a large-scale neural network based on a transformer architecture, having multiple self-attention layers, feed-forward layers, and learned embedding matrices for subword tokens. The model parameters are stored on an external computing resource. The model has been trained on large corpora using unsupervised and supervised learning methods. Training includes defining a loss function such as a cross-entropy loss over predicted next-token probabilities, updating model weights using gradient-based optimization, and applying regularization and data augmentation techniques such as dropout and masking.

During inference, the generative AI model receives the tokenized first prompt sentence as input. The model performs a sequence of matrix multiplications, attention weight computations, and nonlinear activations for each layer to produce probability distributions over output tokens. The model selects output tokens according to a decoding strategy, such as beam search or temperature-controlled sampling, thereby generating a sequence of tokens representing analysis result information. The generative AI model outputs structured analytical content that often includes identified market segments, approximate quantitative assessments, and prioritized action items.

The server receives the analysis result information from the generative AI model via the communication interface. The server stores the analysis result information associated with the corresponding structured data in the storage device. The server then generates second prompt sentences to further refine the analysis result information. The server bases the second prompt sentences on emotion information or application domain information.

The server obtains emotion information by interacting with an emotion analysis processing apparatus. In one embodiment, the emotion analysis processing apparatus is itself realized by a neural network model trained for sentiment and emotion classification. The apparatus receives the consultation text, and optionally other user-generated utterances, as input. The apparatus encodes the text into embeddings, applies a classifier layer that outputs scores for multiple emotion categories (for example, anxiety, confidence, optimism, frustration), and returns emotion evaluation information consisting of categorical labels and associated confidence scores. The training of this apparatus uses labeled data sets with emotion annotations, loss functions such as categorical cross-entropy, and weight updates based on gradient descent. By explicitly using an emotion analysis model separate from the generative AI model, the server obtains a more stable and interpretable representation of user emotional state.

The server then decides how to adapt the generative analysis by referencing rule sets that map emotion evaluation information and application domain information to prompt modification strategies. For example, when the emotion evaluation information indicates a high level of anxiety, the server selects a rule that specifies “increase explanation granularity, include explicit risk mitigation steps, and use more reassuring wording.” When the application domain information indicates “factory process improvement,” the server selects a rule that emphasizes “concise procedural steps, clear numerical targets, and short bullet-point lists.”

The server uses these rules to generate a second prompt sentence such as:

“The user appears highly anxious about launching a new business.

Rewrite the following market analysis and recommendations in a more reassuring and detailed tone.

Explicitly explain risk mitigation strategies, possible fallback options, and realistic implementation timelines.

Original answer: [insert analysis result information here].”

In another example, when the user is confident but needs precise operational steps in a factory scenario, the server generates a second prompt sentence such as: “Rewrite the following production efficiency recommendations into a step-by-step procedure with clear numerical targets and minimal narrative explanation.

Focus on concrete actions for maintenance scheduling, staffing adjustments, and process parameter tuning.

Original answer: [insert analysis result information here].”

The server transmits the second prompt sentence to the generative AI model, which again processes the tokenized text through its transformer layers and produces corrected analysis information. The corrected analysis information has a structure and tone specified by the second prompt sentence and, through the rule mapping, is aligned with the user's emotional state and the application domain.

The server integrates the analysis result information and the corrected analysis information.

The server may, for example, store both versions and mark the corrected analysis information as the primary content while preserving the original analysis result information for traceability. The server can also compute differences between the two outputs, for example by performing sentence-level alignment and diff operations. This integration allows the server to measure how emotion-driven refinement affects content density and complexity, which can be used to further improve prompt-generation rules.

The server generates evaluation information, which includes at least a part of the integrated analysis, the first prompt sentence, and a representation of the inquiry procedure to the generative AI model. The server organizes the evaluation information in a layout suitable for human review on the evaluator terminal. The server provides an evaluator interface that displays the analysis in sections (such as “Market Overview,” “Challenges,” “Recommended Actions”) together with metadata such as time stamps, model version identifiers, and prompt identifiers.

The evaluator uses the evaluator terminal to read the evaluation information and to input corrections. The evaluator terminal sends edited text segments and annotations to the server.

The server merges the corrections with the existing analysis using text processing algorithms, such as segment-based replacement and conflict detection when multiple evaluators provide input. The server then stores the merged content as final answer information.

The server additionally generates processing history information that records, in a machine-readable digital format, the first prompt sentences, the analysis result information, the second prompt sentences, the corrected analysis information, the emotion evaluation information, and the final answer information, together with time stamps and identifiers for each processing stage. The server stores this processing history information in a data structure that supports indexing by case identifier and by time. The server then composes report data that includes the final answer information, process description information summarizing the inquiry procedure, and optionally excerpts of the processing history information. The server transmits this report data to the user terminal via an electronic communication path.

In an example of factory control analysis, the user terminal acquires operation logs from production machines, such as counts of produced units, downtime durations, and defect rates.

The user terminal transmits these logs to the server. The server parses the logs and converts them into structured numerical arrays corresponding to time-ordered sequences. The server computes derived metrics such as moving averages, utilization rates, and variance measures.

The server then generates a specialized prompt sentence such as:

“We have production line data for the last 30 days including throughput, downtime, and defect rates at hourly resolution.

Identify bottleneck processes and propose concrete steps to improve overall equipment effectiveness by at least 10 percent.

Include recommendations for preventative maintenance scheduling, operator shift planning, and process parameter adjustments.”

The generative AI model, receiving detailed numerical context embedded in the prompt sentence, produces recommendations specifically tuned to the pattern of the metrics. The server uses the structured data and analysis to generate actionable guidance that can be used by factory operators to adjust control parameters or maintenance schedules, thereby linking the AI-based analysis to actual machine operation in the physical environment.

This architecture improves computer technology in several ways compared to a naive system that merely forwards user text to a generative AI model and returns raw output. The server performs explicit structuring and normalization of heterogeneous data, which reduces redundancy and enables caching of partial results. Because the server separates prompt generation, emotion analysis, and generative inference into distinct modules with well-defined interfaces, the server can reuse structured data for multiple prompts, lowering the number of tokens transmitted to the generative AI model and thus reducing communication bandwidth and inference time.

The server also uses deterministic rule mappings from emotion evaluation information and application domain information to prompt modification strategies. This rule-based layer is implemented as a table or function library stored in the storage device and accessed by the processor during prompt generation. By centralizing these rules and applying them programmatically, the server reduces variance in prompt design and achieves more predictable model behavior, which leads to improved stability and repeatability of results across cases.

Furthermore, the server maintains detailed processing history information that captures all prompts, intermediate outputs, and emotion evaluations in a machine-readable structure. This allows automatic analysis of historical data to calculate performance metrics such as error rates detected by evaluators, average number of prompt iterations, and average correction volume. The server can use these metrics to automatically tune templates and rule parameters. For example, when the server detects that outputs associated with a certain scenario type frequently require substantial evaluator corrections, the server can adjust template wording or change decoding parameters, which results in a technical feedback loop that optimizes processing efficiency and output quality.

In another embodiment, the server deploys an auxiliary neural network for scenario classification that operates on the structured data and assigns a scenario label. This auxiliary model is a smaller network, for example a convolutional or recurrent network, that processes embedded representations of key tokens. The training of this auxiliary model uses labeled data indicating scenario types, and uses loss functions and optimization methods similar to those described above. This additional model further automates scenario selection and reduces manual configuration.

The server's multi-stage orchestration, in which the processor first generates a first prompt sentence, then obtains a primary analysis, then retrieves emotion evaluation information, then generates a second prompt sentence for correction, and finally integrates and stores all steps in a structured history, is distinct from conventional single-shot prompt systems. The structured pipeline allows the processor to perform partial recomputation when conditions change, such as re-running only the second stage when emotion information is updated, thereby saving computational resources.

By designing the generative AI model interaction and emotion analysis interaction as explicit modules with defined data structures and control flows, the server achieves improvements in processing speed and accuracy that go beyond human manual drafting. The server can process large volumes of user cases in parallel, can cache and reuse structured user information across different analysis scenarios, and can ensure that all intermediate states are recorded for audit and refinement. These features result in reduced latency, reduced network traffic due to optimized prompt sizes, improved consistency of model outputs, and improved alignment of explanation tone with user needs, thereby providing concrete technical effects in the operation of the computing system.

Multiple variations are possible within this framework. The server can substitute different types of generative AI models, such as encoder-decoder architectures trained for domain-specific analysis, while preserving the same prompt sentence generation and processing history functions. The server can also use different emotion analysis apparatuses, such as models based on recurrent neural networks or probabilistic graphical models, without altering the overall data structures or orchestration logic. The server can additionally provide different output formats to the user terminal, such as interactive dashboards or downloadable documents, while still transmitting the same underlying report data.

In each of these embodiments, the server remains responsible for centralizing the conversion of user information into structured data, generating prompt sentences for a generative AI model based on that structured data, integrating emotion evaluation information into subsequent prompt sentences, obtaining corrected analysis information, organizing full processing history information, and transmitting final answer information and process description information to the user terminal.

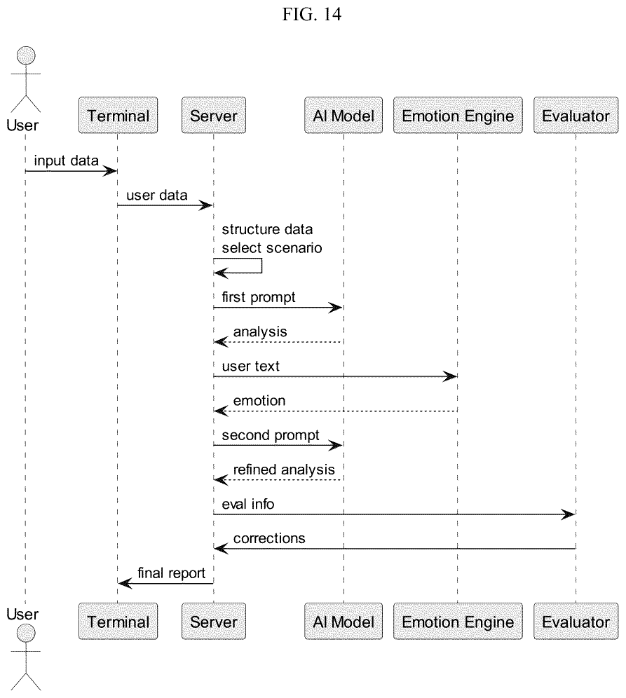

The following describes the processing flow using FIG. 14.

### Step 1

User uses the terminal to input user information.

User operates an input interface on the terminal, such as a web form or application screen, and inputs character information and numerical information including at least a company profile, consultation text, and optional quantitative data such as sales amounts or production metrics.

Terminal receives the input as raw text and numeric values, performs basic validation such as checking required fields and numeric formats, and sets the validated user information as output data to be transmitted to the server.

### Step 2

Terminal transmits validated user information to the server.

Terminal converts the validated user information into a structured message format, attaches metadata such as a session identifier and timestamp, and sends the message to the server via a network protocol.

The input for this step is the validated user information and metadata, and the output is a network request containing the user information delivered to the server.

### Step 3

Server receives user information and converts it into structured data.

Server accepts the network request through a communication interface, extracts the payload, and parses the character information and numerical information.

Server maps text fields to predefined keys (for example, “consultation_text,” “industry_description”) and maps numeric fields to typed numerical arrays. Server applies normalization operations such as trimming whitespace, converting units, and standardizing date formats.

The input for this step is the raw user information sent from the terminal, and the output is structured data stored in memory or a storage device in an internal schema.

### Step 4

Server performs linguistic and domain feature extraction.

Server uses a natural language processing module to tokenize the consultation text, detect language, and extract entities such as industry names, region names, and product categories.

Server calculates domain features, including keyword frequency vectors and sentiment scores, and associates these features with the structured data.

The input for this step is the structured data containing raw consultation text, and the output is enhanced structured data including extracted linguistic and domain features.

### Step 5

Server determines an analysis scenario type.

Server evaluates the extracted domain features using a scenario classification rule set or an auxiliary model to assign a scenario label such as “industry analysis,” “spending management,” or “factory improvement.”

Server uses classification logic, for example keyword matching and probability thresholds, to select the most appropriate scenario type.

The input for this step is the enhanced structured data with domain features, and the output is a scenario label attached to the structured data.

### Step 6

Server generates a first prompt sentence for the generative AI model.

Server selects a prompt template associated with the scenario label and fills designated slots with elements from the structured data, such as company profile, industry description, and specific questions.

Server concatenates template segments and inserted values into a coherent prompt sentence.

For example, server generates a prompt sentence such as:

“You are a market analysis assistant. A company plans to launch a new eco-friendly household products category in a national online retail market. Analyze market size, competitive landscape, growth potential over the next 3-5 years, and key challenges, and propose 3-5 concrete strategies for market entry.”

The input for this step is the structured data and scenario label, and the output is a first prompt sentence ready to be sent to the generative AI model.

### Step 7

Server transmits the first prompt sentence to the generative AI model and receives analysis result information.

Server calls an external API or model interface, encodes the first prompt sentence as a sequence of tokens, and submits the tokens to the generative AI model.

Generative AI model processes the tokens through internal layers and returns a token sequence representing analytical text. Server decodes the tokens back into text and stores the result as analysis result information.

The input for this step is the first prompt sentence, and the output is analysis result information generated by the generative AI model and stored on the server.

### Step 8

Server associates analysis result information with user information.

Server links the analysis result information with the corresponding structured data using a case identifier.

Server writes the association into a persistent store so that all outputs and inputs for the same case are retrievable together.

The input for this step is the analysis result information and the structured data identifier, and the output is a linked record that ties user information and analysis result information.

### Step 9

Server obtains emotion evaluation information from an emotion analysis processing apparatus.

Server extracts relevant text segments from the user information, such as the consultation text and any supplementary comments, and transmits these segments to an emotion analysis module.

The emotion analysis module computes emotion scores, for example anxiety or confidence levels, and returns emotion evaluation information. Server receives the information and stores it with the case data.

The input for this step is the user-related text, and the output is emotion evaluation information represented as structured emotion labels and scores.

### Step 10

Server generates a second prompt sentence based on analysis result information and emotion evaluation information.

Server applies predetermined rules that map emotion labels and scenario labels to prompt modification strategies. Server uses these strategies to construct a second prompt sentence that instructs the generative AI model to refine or rewrite the initial analysis.

For example, when emotion evaluation indicates anxiety, server generates a second prompt sentence such as:

“The user appears highly anxious about launching a new business. Rewrite the following analysis in a more reassuring and detailed tone, explicitly explaining risk mitigation strategies and realistic implementation timelines. Original answer: [insert analysis result information].”

The input for this step is the analysis result information and emotion evaluation information, and the output is a second prompt sentence configured for refinement.

### Step 11

Server transmits the second prompt sentence to the generative AI model and receives corrected analysis information.

Server encodes the second prompt sentence into tokens and provides them to the generative AI model via the same model interface.

Generative AI model generates a refined output sequence that reflects the instructions in the second prompt sentence. Server decodes the tokens into text and registers the output as corrected analysis information.

The input for this step is the second prompt sentence, and the output is corrected analysis information adapted to the user's emotional state and scenario.

### Step 12

Server integrates analysis result information and corrected analysis information into analysis result output information.

Server combines the original and corrected outputs, for example by designating the corrected analysis information as primary content and retaining the original analysis result information as a reference.

Server may apply text comparison to identify changes and store integration metadata indicating which parts were altered.

The input for this step is the analysis result information and the corrected analysis information, and the output is integrated analysis result output information that is ready for evaluation.

### Step 13

Server constructs evaluation information and provides it to the evaluator terminal.

Server formats the analysis result output information, the first prompt sentence, and an outline of the inquiry procedure into a layout suitable for display on an evaluator interface.

Server transmits this evaluation information to the evaluator terminal. The evaluator terminal receives the information, renders segments on a display, and provides editing tools for the evaluator.

The input for this step is the analysis result output information and associated metadata, and the output is evaluation information displayed on the evaluator terminal.

### Step 14

Evaluator uses the evaluator terminal to input correction data, and the evaluator terminal sends the correction input to the server.

Evaluator edits text, comments on specific segments, and confirms changes through the evaluator terminal.

Evaluator terminal packages the edited content and annotations and transmits them back to the server as correction input. The input for this step is the evaluation information presented on the evaluator terminal, and the output is correction input data delivered to the server.

### Step 15

Server generates final answer information based on correction input.

Server merges the correction input with the analysis result output information, replacing or augmenting sections as indicated by the evaluator's edits.

Server stores the merged content as final answer information in association with the case identifier.

The input for this step is the analysis result output information and the correction input, and the output is final answer information that has been validated by an evaluator.

### Step 16

Server organizes processing history information and process description information.

Server aggregates all relevant elements for the case, including the first and second prompt sentences, the analysis result information, the corrected analysis information, the emotion evaluation information, and the final answer information.

Server arranges these elements into a structured representation, such as a time-ordered event list or a hierarchical record, and summarizes key steps into process description information that explains the inquiry procedure and main analysis stages.

The input for this step is all intermediate and final data associated with the case, and the output is processing history information and process description information.

### Step 17

Server generates report data and transmits it to the user terminal.

Server combines the final answer information, process description information, and, optionally, selected parts of the processing history information into report data formatted for user consumption.

Server sends the report data via an electronic communication path to the user terminal. The user terminal receives the report data, renders the content on a display, and allows the user to read the final answer and, where appropriate, summaries of the processing procedure.

The input for this step is the final answer information and associated descriptive information, and the output is displayed report content on the user terminal.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

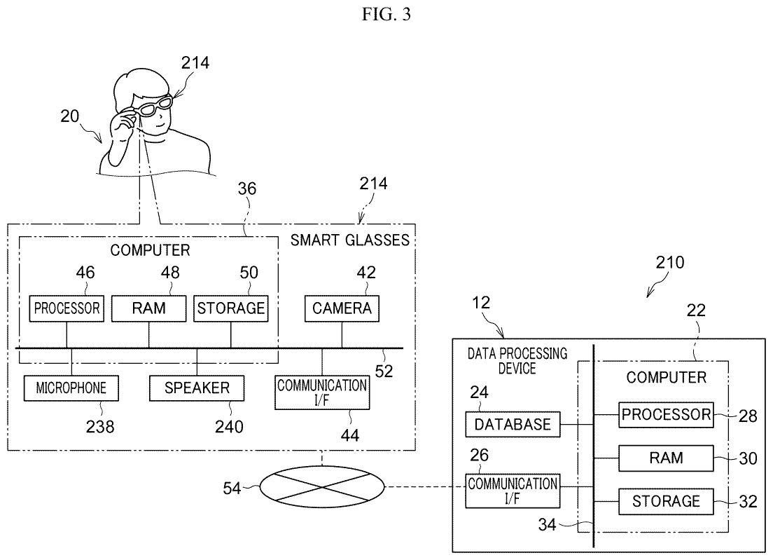

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52.

The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

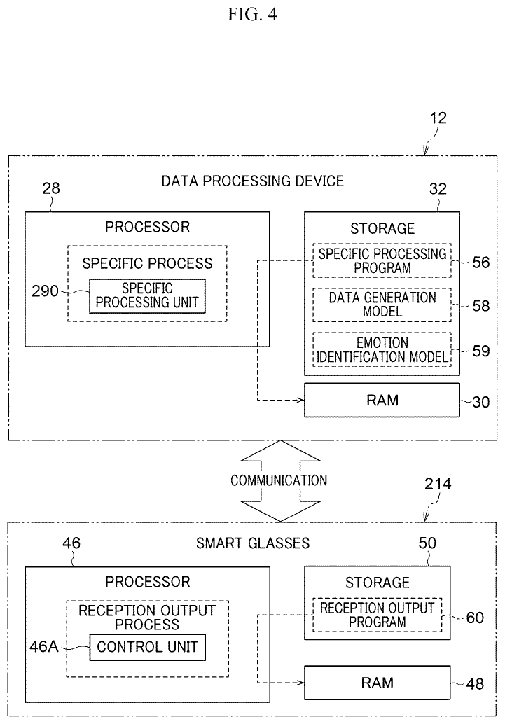

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

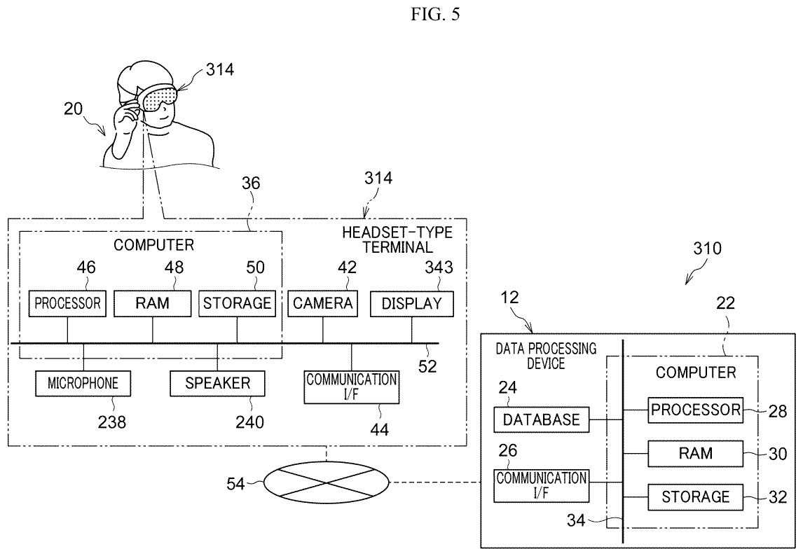

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

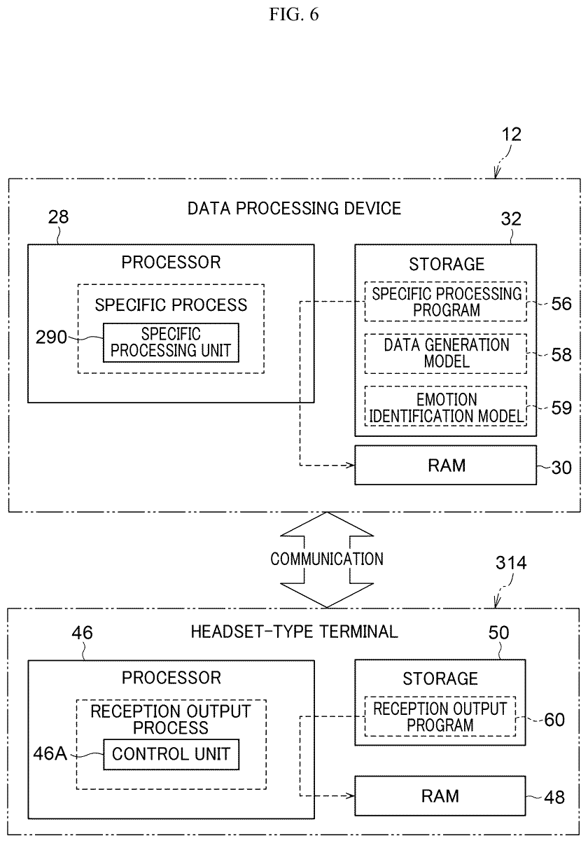

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

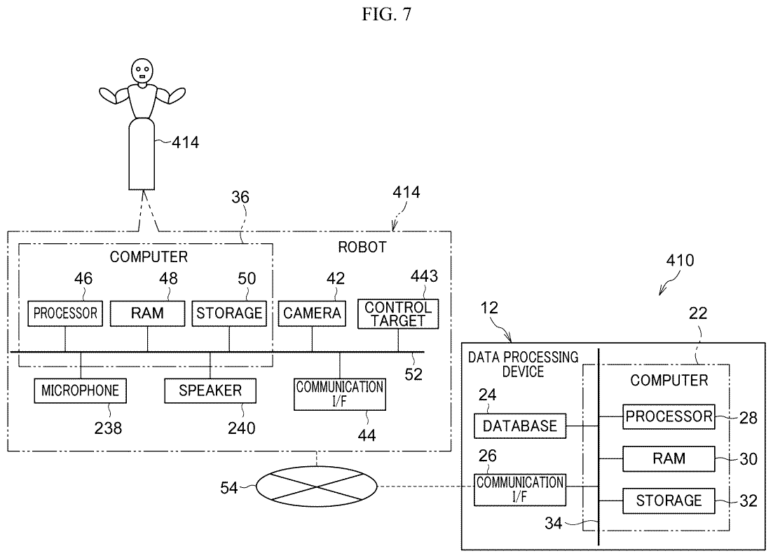

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

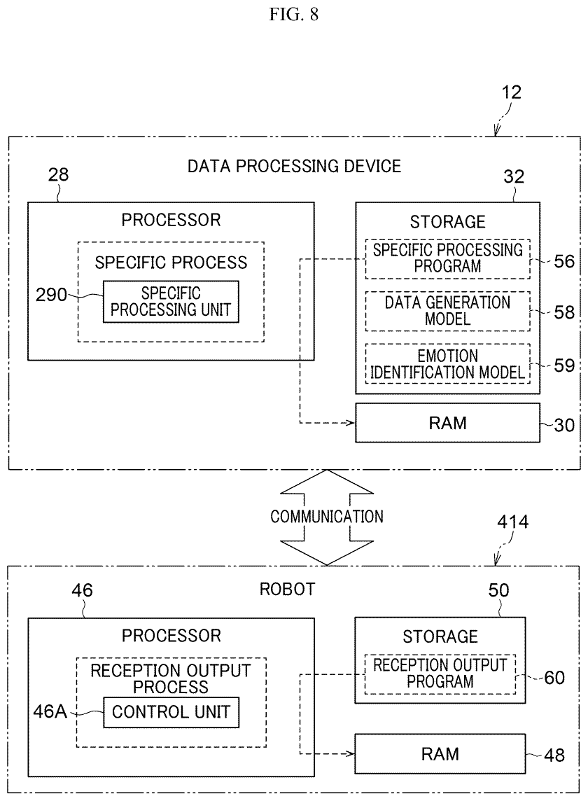

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

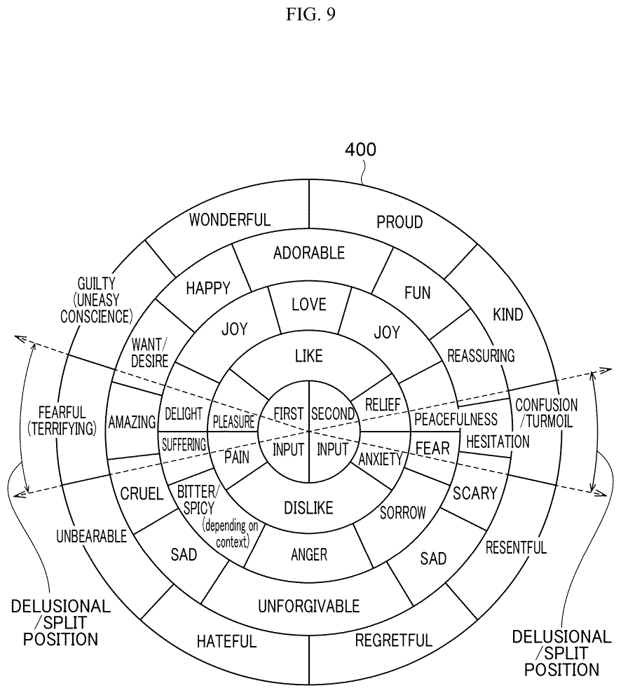

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

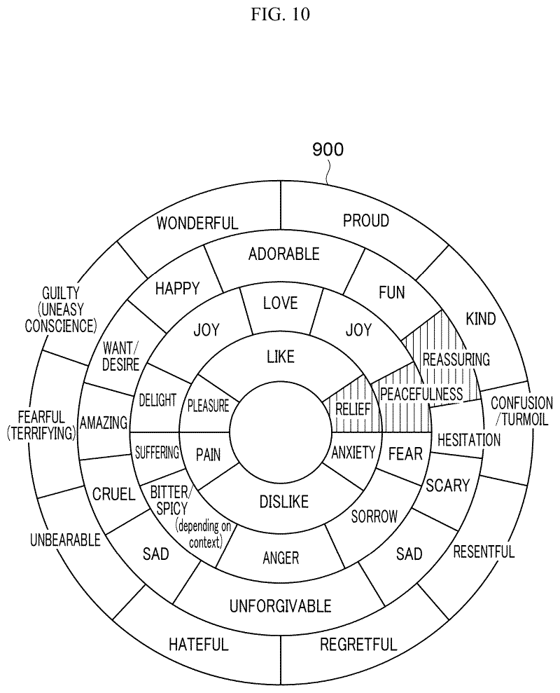

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via a communication network from a terminal, input information including organization attribute information, user attribute information, and consultation content information that a user has entered through an information input screen, analyze the input information, and store the analyzed information as inquiry data including the consultation content information,
estimate, based on the consultation content information, at least one of an industry category and an issue category, refer to template information associated with a result of the estimation, construct a prompt sentence that instructs a generative AI model to generate output including at least industry analysis information, industry issue information, and initiative information, and transmit the prompt sentence, in accordance with a communication protocol, to an external information processing service that includes the generative AI model,
receive, from the generative AI model in response to the prompt sentence, answer text, perform at least one of formatting processing, safety checking processing, and structuring processing on the answer text, and store the processed answer text as draft answer data including the industry analysis information, the industry issue information, and the initiative information,
provide, via the communication network, the draft answer data and the consultation content information to a terminal of an evaluator having expert knowledge, receive correction information transmitted from the terminal of the evaluator, and generate expert-verified final answer data by reflecting the correction information in the draft answer data, and
organize the prompt sentence, the answer text obtained from the generative AI model, the expert-verified final answer data, and processing history information including procedures for obtaining the answer text by using the generative AI model into digital information in a message format or a viewing-screen format, and transmit or provide the digital information to the user by using an electronic communication means.

### Supplementary 2

The system according to supplementary 1,
wherein the processor is configured to
execute emotion analysis processing on at least one of the consultation content information and the answer text obtained from the generative AI model by using an emotion analysis function to extract emotion tendency information, and adjust at least one of expression content and presentation order of the draft answer data or the expert-verified final answer data in accordance with the emotion tendency information.

### Supplementary 3

The system according to supplementary 1,
wherein the processor is configured to
structure the prompt sentence, the answer text obtained from the generative AI model, the emotion tendency information, and the expert-verified final answer data into a digital format in an electronic document format or a web-screen format, and transmit the structured digital format as an analysis report that is to be provided to the user via an electronic communication means or a web platform.

### Application Example 1

### Supplementary 1

A system comprising a processor, a storage device, a communication interface, and a user terminal,
wherein the processor is configured to
receive, via the communication interface, attribute information including an organization identifier, an individual identifier, contact information, and consultation content that a user inputs by operating the user terminal, and store the received attribute information in the storage device,
generate, based on the stored attribute information including the consultation content, a prompt sentence as character information for querying a generative artificial intelligence model, and construct inquiry data including the prompt sentence,
transmit, via the communication interface, the inquiry data to an external information processing apparatus that provides the generative artificial intelligence model, and receive, via the communication interface, analysis result information as electronic data from the generative artificial intelligence model, the analysis result information including industry analysis information, industry issue information, and initiative information,
store, in the storage device in association with each other, the analysis result information and the prompt sentence, convert the analysis result information into review data that is displayable on a display screen for an evaluator having expert knowledge, and generate final answer information by modifying the analysis result information in accordance with an edit operation input from the evaluator,
format the final answer information into at least one digital format selected from an electronic mail format and a network-based viewing screen format, and transmit, via the communication interface, the formatted final answer information to the user terminal operated by the user, and
manage, as a history in the storage device, the inquiry procedure to the generative artificial intelligence model, the prompt sentence, the analysis result information, and the final answer information in association with one another, and generate report data configured to report an analysis process and an analysis result to the user based on the history.

### Supplementary 2

The system according to supplementary 1,
wherein the processor is configured to input emotion-related information or response information obtained from the user into an information processing function having emotion analysis capability to estimate emotion state information, and adjust at least one of an expression format and a presentation order of the final answer information based on the emotion state information.

### Supplementary 3

The system according to supplementary 1,
wherein the processor is configured to organize an information group including the inquiry procedure to the generative artificial intelligence model, the prompt sentence, the analysis result information, the emotion state information, and the final answer information into a structured digital format, and provide the structured digital format, via the communication interface, to at least one of the user and the evaluator in a form viewable on an electronic communication medium or an information providing platform.

### Example 2

### Supplementary 1

A system comprising a processor,
wherein the processor is configured to
receive consultation information input from a use terminal, analyze the consultation information to extract classification information indicating a target field and a target region, and determine, based on the classification information, types of market-related information to be obtained from an external information source,
access, based on the classification information, an information acquisition interface provided by an external information providing apparatus via a communication network, obtain, as the market-related information, numerical information and text information including market size information, competitive situation information, and growth potential information, normalize the obtained market-related information into a unified format, and store the normalized market-related information in an internal storage area,
construct, based on the consultation information and the market-related information, a prompt sentence including instruction content for a generative AI model, embed the market-related information as context information into the prompt sentence, and generate query information that instructs the generative AI model to generate industry analysis information, industry challenge information, and countermeasure information,
transmit the query information to the generative AI model, receive, from the generative AI model, analysis result information including the industry analysis information, the industry challenge information, and the countermeasure information automatically generated based on the prompt sentence, and store the received analysis result information as structured data in a storage device,
present the analysis result information to an evaluator having expert knowledge, accept correction information and additional information from the evaluator, and verify and edit the analysis result information based on the correction information and the additional information to generate final answer information,
manage a relationship among the consultation information, the prompt sentence, the market-related information, the analysis result information, and the final answer information, and generate report information including a procedure of querying the generative AI model and summary content of the analysis result information, and
transmit the final answer information and the report information in a digital format to the use terminal or an information browsing service via an electrical communication medium, and provide the final answer information and the report information to a user.

### Supplementary 2

The system according to Supplementary 1,
wherein the processor is configured to
acquire emotion-related information regarding the user, execute emotion estimation processing on the consultation information or the final answer information by using an emotion analysis function, and adjust a representation format or a presentation order of the analysis result information and the final answer information in accordance with the emotion-related information.

### Supplementary 3

The system according to Supplementary 1,
wherein the processor is configured to
convert the consultation information, the market-related information, the prompt sentence, the analysis result information, the final answer information, and the emotion-related information into a document format or a data format displayable on an electronic viewing medium, organize the information on a section basis, and output the information as a digital format in which the sections are mutually referable based on identification information, for provision via the electrical communication medium or an information providing network infrastructure.

### Application Example 2

### Supplementary 1

A system comprising a processor,
wherein the processor is configured to
receive user information acquired from a user terminal, convert character information and numerical information included in the user information into structured data, and store the structured data in a storage device,
generate a first prompt sentence including instruction content for causing an external generative AI model to generate at least one of industry analysis, industry issues, and action plans based on the structured data, transmit the first prompt sentence to the external generative AI model via a communication interface, and obtain analysis result information from the external generative AI model,
associate the analysis result information with the user information, generate a second prompt sentence including additional input corresponding to emotion information or application domain information, transmit the second prompt sentence to the external generative AI model, and obtain corrected analysis information in which the analysis result information is corrected by the external generative AI model,
integrate the corrected analysis information and the analysis result information to generate industry analysis result information, generate evaluation information including at least a part of the industry analysis result information, the first prompt sentence, and a procedure of inquiries to the external generative AI model, and transmit the evaluation information to an evaluator terminal and receive correction input from an evaluator via the evaluator terminal to generate final answer information, and
generate process description information summarizing the procedure of inquiries to the external generative AI model and the analysis result information, and transmit, via an electronic communication path, the final answer information and the process description information to the user terminal.

### Supplementary 2

The system according to supplementary 1,
wherein the processor is configured to
input the user information or additional utterance information acquired from a user into an emotion analysis processing apparatus, obtain emotion evaluation information from the emotion analysis processing apparatus, and change at least one of a description style of the first prompt sentence and an expression style of the corrected analysis information according to the emotion evaluation information so as to adjust content or tone of explanation in the industry analysis result information.

### Supplementary 3

The system according to supplementary 1,
wherein the processor is configured to
organize, in a machine-readable digital format, processing history information including the first prompt sentence, the analysis result information, the corrected analysis information, the emotion evaluation information, and the final answer information, and transmit, via an electronic communication path or a network-based information providing platform, the processing history information as report data to the user terminal.

What is claimed is:

1. A system comprising:
a communication interface connected to a packet-switched network; and
circuitry configured to:
receive, via the communication interface, input data from a terminal device, the input data comprising attribute data and text data entered by a user;
analyze the text data to estimate a category classification from among a plurality of predefined categories stored in a data storage device;
retrieve, from the data storage device, template data associated with the estimated category classification;
construct, based on the text data, the attribute data, and the template data, a prompt data structure configured to instruct a generative neural network model to produce analytical output comprising at least a domain analysis segment, an issue identification segment, and a proposed action segment;
transmit, via the communication interface, the prompt data structure to the generative neural network model;
receive, from the generative neural network model, response data comprising the analytical output;
perform at least one of formatting processing, safety verification processing, and structuring processing on the response data to generate draft output data;
transmit the draft output data to an evaluator terminal device via the communication interface and receive correction data from the evaluator terminal device;
generate verified output data by incorporating the correction data into the draft output data; and
transmit, via the communication interface, the verified output data to the terminal device.

2. The system according to claim 1, wherein the circuitry is further configured to:
organize the prompt data structure, the response data, and the verified output data into a structured digital document comprising a processing history section describing a procedure used to obtain the response data from the generative neural network model; and
transmit the structured digital document to the terminal device via the communication interface.

3. The system according to claim 2, wherein the structured digital document is formatted in at least one of an electronic message format and a network-based display screen format.

4. The system according to claim 1, wherein the circuitry is further configured to:
estimate an emotional state of the user based on at least one of voice data, image data, and the text data received from the terminal device; and
adjust at least one of expression content, presentation order, and a level of detail of the draft output data or the verified output data based on the estimated emotional state.

5. The system according to claim 4, wherein the emotional state is estimated using an emotion identification model that maps input data to emotion values on an emotion map in which a plurality of emotions are arranged based on a structure giving rise to the emotions.

6. The system according to claim 4, wherein the circuitry is further configured to include the estimated emotional state in the prompt data structure to cause the generative neural network model to generate the response data with a tone and detail level adapted to the emotional state.

7. The system according to claim 1, wherein the circuitry is further configured to:
access, via the communication interface, an external information source to acquire supplementary data corresponding to the estimated category classification;
normalize the supplementary data into a structured format; and
include the normalized supplementary data in the prompt data structure prior to transmitting the prompt data structure to the generative neural network model.

8. The system according to claim 7, wherein the supplementary data comprises at least one of numerical data and text data obtained from a publicly accessible information providing apparatus via the packet-switched network.

9. The system according to claim 1, wherein the generative neural network model comprises a transformer architecture including an embedding layer, a plurality of self-attention layers, a plurality of feed-forward layers, and an output projection layer.

10. The system according to claim 1, wherein the circuitry is further configured to:
generate a second prompt data structure based on the draft output data and additional input corresponding to the estimated emotional state or user-specified parameters; and
transmit the second prompt data structure to the generative neural network model to receive refined response data.

11. The system according to claim 1, wherein the circuitry is further configured to:
store, in the data storage device, the prompt data structure, the response data, the correction data, and the verified output data in association with one another; and
retrieve, for a subsequent input data having a category classification matching a previously stored category classification, at least a portion of a previously stored prompt data structure for reuse.

12. The system according to claim 1, wherein the circuitry is further configured to:
convert, prior to constructing the prompt data structure, the attribute data and the text data into structured data comprising key-value pairs organized according to a predefined schema.

13. The system according to claim 1, wherein the circuitry is further configured to:
present, on a display of the evaluator terminal device, a comparison view comprising the draft output data and the text data; and
receive, from the evaluator terminal device, the correction data as annotated modifications to the draft output data.

14. The system according to claim 7, wherein the circuitry is further configured to:
compute a confidence score for each segment of the analytical output based on consistency with the supplementary data or historical output data stored in the data storage device; and
flag segments having a confidence score below a threshold for prioritized review by an evaluator.

15. The system according to claim 1, wherein the circuitry is further configured to:
generate a plurality of prompt data structures differing in at least one of scope, detail level, and analytical perspective;
transmit each of the plurality of prompt data structures to the generative neural network model; and
aggregate the response data received from each prompt data structure into a consolidated draft output data.

16. The system according to claim 1, wherein the text data comprises data describing operational conditions and the analytical output comprises at least a classification of operational challenges and recommended operational adjustments.

17. The system according to claim 1, wherein the circuitry is further configured to:
record a timestamp and a version identifier for each of the draft output data, the correction data, and the verified output data; and
maintain, in the data storage device, an audit trail associating each version with the corresponding processing step.

18. A system comprising:
a communication interface connected to a packet-switched network;
a data storage device; and
circuitry configured to:
receive, via the communication interface, input data comprising attribute data and text data from a terminal device;
estimate a category classification based on the text data;
construct a prompt data structure based on the input data and template data associated with the category classification;
transmit the prompt data structure to a generative neural network model and receive response data comprising analytical output;
perform at least one of formatting processing and safety verification processing on the response data to generate draft output data;
transmit the draft output data to an evaluator terminal device, receive correction data, and generate verified output data;
organize the prompt data structure, the response data, and the verified output data into a structured digital document; and
transmit the verified output data and the structured digital document to the terminal device via the communication interface.

19. A method comprising:
receiving, by circuitry via a communication interface connected to a packet-switched network, input data from a terminal device, the input data comprising attribute data and text data;
analyzing, by the circuitry, the text data to estimate a category classification;
constructing, by the circuitry, a prompt data structure based on the text data, the attribute data, and template data associated with the category classification;
transmitting the prompt data structure to a generative neural network model and receiving response data comprising analytical output;
performing at least one of formatting processing and safety verification processing on the response data to generate draft output data;
transmitting the draft output data to an evaluator terminal device and receiving correction data;
generating verified output data by incorporating the correction data into the draft output data; and
transmitting the verified output data to the terminal device via the communication interface.
